(19) United States
(12) Patent Application Publication
(10) Pub. No.: US 2026/0346919 A1
(43) Pub. Date: Nov. 5, 2026

(54) MODULAR VEHICLE MULTI-PLANE CHASSIS SYSTEM

(71) Applicant: Hummingbird EV, Livermore, CA (US)

(72) Inventors: Vinay JAYACHAND, Livermore, CA (US); Michael VAN STEENBURG, Livermore, CA (US); Apple MAHMUD, Livermore, CA (US)

(21) Appl. No.: 19/488,547

(22) PCT Filed: May 31, 2024
(86) PCT No.: PCT/US2024/032114

§ 371 Date: Nov. 26, 2025

Related U.S. Application Data
(63) Continuation of application No. 18/679,340, filed on May 30, 2024, now abandoned.
(60) Provisional application No. 63/505,673, filed on Jun. 1, 2023.

(51) Int. Cl. B62D 21/03; B62D 21/17; B62D 24/00; B62D 27/02

(52) U.S. Cl. CPC B62D 21/03; B62D 21/17; B62D 24/00; B62D 27/026

(57) ABSTRACT

The various embodiments described herein include devices and components for chassis systems and/or assemblies. In one aspect, a multi-plane chassis assembly includes a plurality of pultruded frame members, a first subset of the pultruded frame members being arranged on a first structural plane, and a second subset of the pultruded frame members being arranged on a second structural plane, the first structural plane being at a different vertical position than the second structural plane. The multi-plane chassis assembly further includes a plurality of cross members connecting the plurality of pultruded frame members to one another, the plurality of cross members are connected to the plurality of pultruded frame members and arranged to maintain a geometric relationship between pultruded frame members of the plurality of pultruded frame members, where each cross member of the plurality of cross members extends between at least two structural planes.

### PRIORITY AND RELATED APPLICATIONS

This application is a continuation and claims priority to U.S. patent application Ser. No. 18/679,340, entitled “Modular Vehicle Multi-Plane Chassis System” filed on May 30, 2024, which claims priority to U.S. Prov. App. No. 63/505,673, filed on Jun. 1, 2023, and entitled “Modular Vehicle Multi-Plane Chassis System,” which are hereby incorporated by reference in their entireties.

### TECHNICAL FIELD

The disclosed embodiments relate generally to chassis systems and components, including but not limited to multi-plane chassis assemblies, such as a modular dual plane (bi-level) chassis assembly for an electric vehicle (EV).

### BACKGROUND

A chassis assembly provides structural, load-bearing support for a vehicle. A chassis assembly may provide a platform on which the components of the vehicle are placed (e.g., the axles, engine, cab, fuel tank, and/or batteries). A chassis assembly may be required to provide impact resistance during a collision to protect the other components and any occupants, and may also be required to flex or bend (e.g., deflect) when the vehicle is turning or accelerating. Because different vehicles require components to be in different arrangements, conventional chassis assemblies are specific to individual vehicles.

### SUMMARY

The present disclosure describes chassis systems and subsystems. The disclosed embodiments include a modular multi-plane (e.g., a dual-plane and/or bi-level structure) vehicle chassis system, e.g., with features for electrified vehicle platforms. For example, the vehicle chassis may include two or more structural planes that form a longitudinal truss system that also resists torsional loads on the chassis. The disclosed modular multi-plane vehicle chassis systems can provide a chassis that is stiffer in torsion and can provide greater bending stiffness and increased energy absorption in comparison to a conventional single plane ladder frame chassis system (e.g., single plane structures) for vehicles of all weight classes, while also providing one or more additional structural planes (as compared to a single-chassis assembly) for securely attaching vehicle components.

In accordance with some embodiments, a multi-plane chassis assembly includes: (i) a plurality of pultruded frame members, a first subset of the pultruded frame members being arranged on a first structural plane, and a second subset of the pultruded frame members being arranged on a second structural plane, the first structural plane being at a different vertical position than the second structural plane; and (ii) a plurality of cross members connecting the plurality of pultruded frame members to one another, the plurality of cross members are connected to the plurality of pultruded frame members and arranged to maintain a geometric relationship between pultruded frame members of the plurality of pultruded frame members, where each cross member of the plurality of cross members extends between at least two structural planes. In some circumstances, the pultruded frame members are lighter than conventional metal frame members, which reduces the weight of the chassis and therefore the vehicle.

Thus, devices and components are disclosed for chassis systems and assemblies. Such devices and components may complement or replace conventional devices and components for chassis systems and assemblies.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIGS. 1A-1B illustrate an example chassis assembly in accordance with some embodiments.

FIG. 2 illustrates another example chassis assembly in accordance with some embodiments.

FIGS. 3A-3B illustrate example assemblies with tanks in accordance with some embodiments.

FIGS. 4A-4B illustrate example assemblies with bus bars in accordance with some embodiments.

FIGS. 5A-5B illustrate an example frame member in accordance with some embodiments.

FIGS. 6A-6B illustrate example frame members with connector components in accordance with some embodiments.

FIGS. 7A-7D illustrate example frame members with connector components in accordance with some embodiments.

FIGS. 8A-8B illustrate example joint systems in accordance with some embodiments.

FIGS. 8C-8D illustrate example attachment systems in accordance with some embodiments.

FIG. 8E illustrates an example joint system in accordance with some embodiments.

FIG. 9 illustrates an example cross member component in accordance with some embodiments.

FIGS. 10A-10B illustrate an example belly pan assembly in accordance with some embodiments.

FIGS. 11A-11F illustrate an example cab assembly in accordance with some embodiments.

FIG. 12 illustrates an example chassis assembly in accordance with some embodiments.

FIGS. 13A-13D illustrate an example chassis assembly that includes example battery pack storage modules, in accordance with some embodiments.

FIG. 14 illustrates a deflection force diagram indicating magnitudes of force acting on the chassis assembly during a simulated cornering sequence, in accordance with some embodiments.

FIGS. 15A-15C illustrate a cradle 1500 for use with a modular chassis assembly, in accordance with some embodiments.

FIGS. 16A and 16B illustrate a pultrusion cover 1600, in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes, among other things, a chassis system that includes a plurality of frame members coupled to (e.g., jointed to) a plurality of cross members. The chassis system may be a multi-plane (e.g., a dual-plane) chassis system where the cross members are shaped to couple to frame members at different structural planes. The chassis system may also include a variety of brackets for coupling different components to the chassis system (e.g., coupling a drivetrain, a battery system, and/or a powertrain). The disclosed chassis systems may be stiffer and may provide greater bending stiffness and increased energy absorption in comparison to conventional chassis systems.

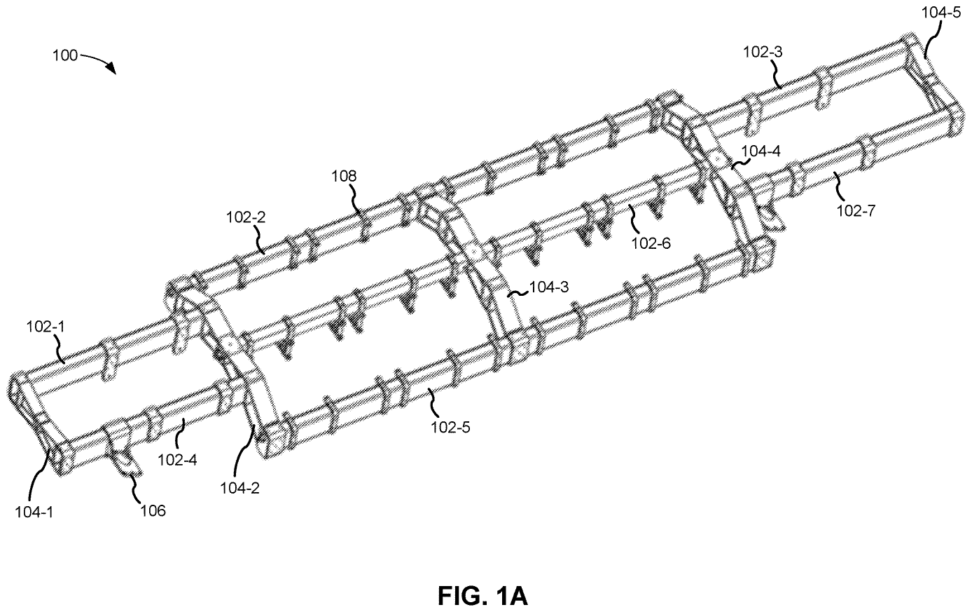

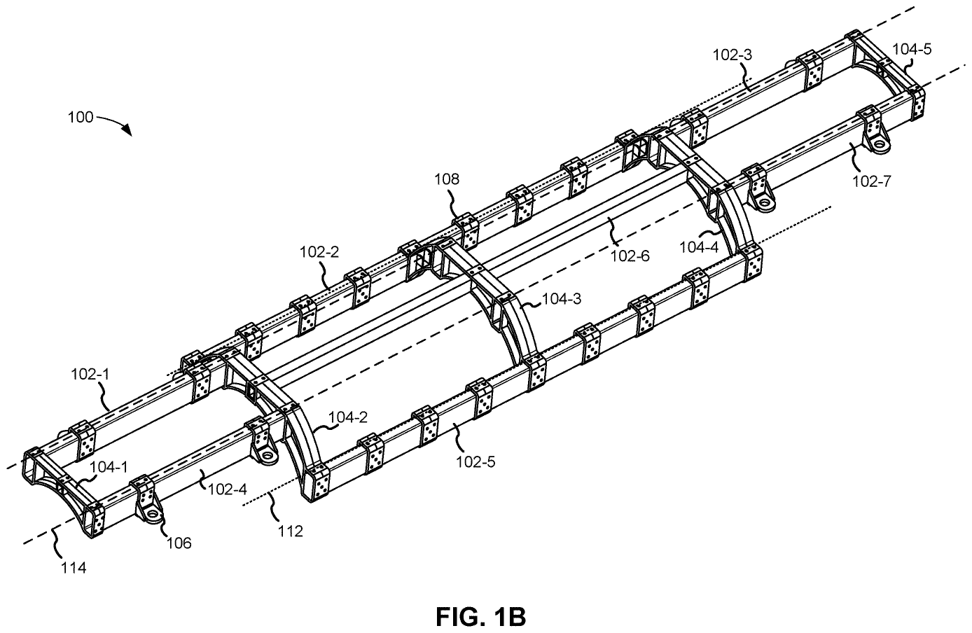

FIGS. 1A-1B illustrate a chassis assembly 100 in accordance with some embodiments. The chassis assembly 100 includes frame members 102 (e.g., the frame members 102-1, 102-2, 102-3, 102-4, 102-5, 102-6, and 102-7) and cross members 104 (e.g., the cross members 104-1, 104-2, 104-3, 104-4, and 104-5). The chassis assembly 100 also includes bracket 106 (e.g., a first type of bracket) and bracket 108 (e.g., a second type of bracket). In some embodiments, the brackets 106 and/or 108 are used to connect a tray to the chassis assembly 100. FIG. 1B also illustrates that the frame members 102-1, 102-3, 102-4, and 102-7 are on a first plane indicated by dashed lines 114, and the frame members 102-2 and 102-5 are on a second plane indicated by dotted lines 112.

In some embodiments, the frame members 102 include pultruded frame members (e.g., pultruded composite frame members). In some embodiments, the frame members 102 are composed of a composite of metal and one or more fibers (e.g., carbon fibers). In some embodiments, the chassis assembly 100 is a dual-plane chassis assembly. In some embodiments, the chassis assembly 100 includes more than two planar elements (e.g., the chassis assembly 100 is a multi-plane chassis assembly). In some embodiments, the frame members 102 are composed of unidirectional or multi-axial organic or non-organic fibers. In some embodiments, the arrangement of frame members and cross members for the chassis assembly is adjustable. In some embodiments, the chassis assembly is adjusted based on a wheelbase of the vehicle for which the chassis assembly is to be used. For example, the chassis assembly 100 can be used with different vehicle types by adjusting where the cross members 104 attach to the frame members 102.

In some embodiments, the frame members 102 are composed of a matrix of chemically cross-linked resin or metallic material, e.g., that when pulled through a die of sufficient shape and contour (with or without a curing element), creates a rigid structural member. In some embodiments, the frame members 102 are composed of polyester fiber (e.g., arranged in a matrix pattern). In some circumstances the matrix pattern of fibers improves structural integrity of the chassis assembly (e.g., 10×-15× with static load conditions). In some circumstances, the frame members are less costly than other types of frame members (e.g., due to lower capital expenditure) and/or require less energy consumption to produce.

In some embodiments, portions of the frame members 102 (e.g., the frame rails) comprise a laminar composite. In some embodiments, the laminar component is composed of two-dimensional sheets or panels (e.g., plies or laminae) bonded to one another. In some embodiments, two or more plies have different orientations, such as being substantially orthogonal to one another (e.g., are cross-plied). For example, the two or more plies may have alternating high-strength layer orientations between 0 and 90 degrees. In some embodiments, two or more plies are angle-plied (e.g., successive layers alternating between respective positive and negative angular orientations). In some embodiments, the two or more plies are arranged in alternating high-strength orientations (e.g., ±45 degrees). By using the respective plying patterns (e.g., layup patterns of the fibers), the frame can be configured to withstand non-linear and multi-directional forces, which may be beneficial particularly during vehicle braking, cornering, downhill deceleration, uphill acceleration, etc. However, a skilled artisan having read this disclosure will appreciate that other plying patterns and/or other techniques for layer components may be used.

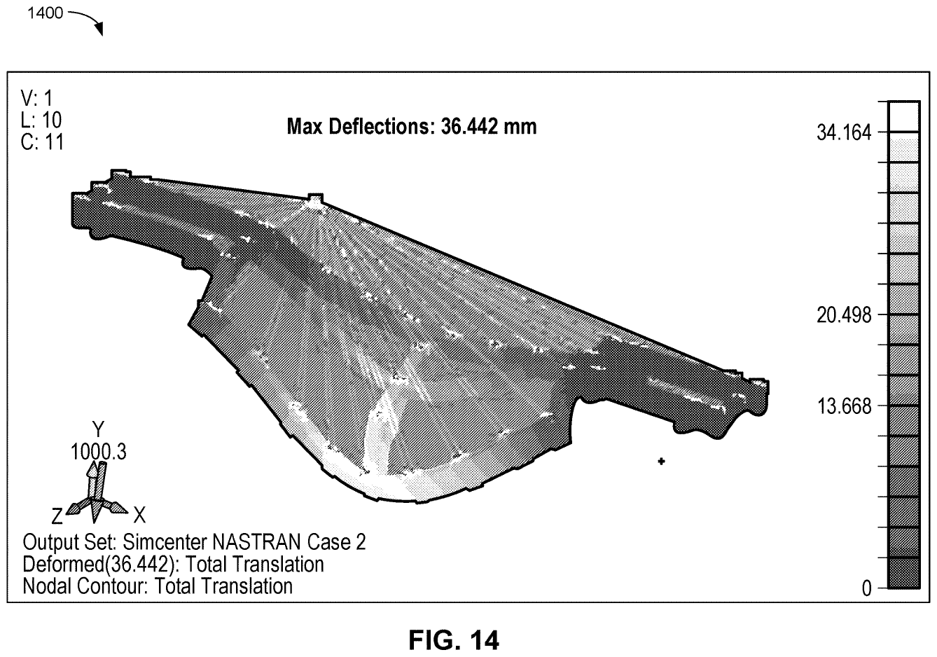

In some embodiments, the chassis assembly 100 is configured to receive multi-directional force from a maneuver (e.g., braking, cornering, on graded terrain, and/or during acceleration and deceleration). In some embodiments, a detailed finite element method (FEM) analysis is performed, as described in FIG. 14, where the detailed FEM analysis includes summarizing the directional force to determine an optimal composite ply orientation. In some embodiments, the chassis assembly 100 is configured to deflect less than a predetermined amount during operation (e.g., less than 50 mm, 40 mm, or 37 mm). In some embodiments, an amount of deflection is determined using the FEM analysis. In this way, a vehicle using the chassis assembly 100 meets road and operational safety requirements.

In some embodiments, the chassis assembly 100 is composed of extruded aluminum (e.g., the frame members 102 and/or the cross members 104). In some embodiments, the chassis assembly 100 includes a plurality of aluminum extrusions. In some embodiments, a wall thickness of the aluminum extrusions is different than a wall thickness of the frame members 102 (e.g., the frame members 102 are pultruded composite frame members). In some embodiments, the extruded aluminum material includes one or more types of foreign fibers, such as carbon or boron (e.g., that enhance the stiffness properties of the base aluminum material). In some embodiments, one or more battery components are arranged between the frame member 102-2 and the frame member 102-5. In some embodiments, a cradle assembly is arranged between the frame member 102-1 and the frame member 102-4.

In some embodiments, a frame member of the frame members 102 has a same outer perimeter shape as a pultruded composite frame rail. In some embodiments, a wall thickness of the extrusions is greater than a wall thickness of the pultruded composite frame rails (e.g., in order to match the frame rail section stiffness properties required for the complete chassis assembly to meet performance specifications of the vehicle).

In some embodiments, the chassis assembly 100 is a pultruded composite multi-plane assembly. In some embodiments, the chassis assembly 100 is a vehicle chassis assembly. In some embodiments, one or more of the frame members 102 is a pultruded frame rail (e.g., adapted to support longitudinal loads on the chassis assembly). In some embodiments, the pultruded frame rails have the same cross-sections. In some embodiments, the frame members 102 contain one or more pneumatic, hydraulic, electrical, and/or electronic components. In some embodiments, the cross members 104 are arranged and connected to the frame members 102 to maintain the geometrical relationship between the frame members 102. In some embodiments, the cross members 104 provide load carrying support against torsional loads and skewing loads of a vehicle chassis assembly.

In some embodiments, the cross members 104 are composed of ferrous materials, composite materials, and/or non-ferrous materials. In some embodiments, the cross members 104 contain electrical and/or electronic components (e.g., that provide vehicle energy management). In some embodiments, the cross members 104 contain sensors that provide vehicle load feedback data to the vehicle control system. In some embodiments, the bracket 106 and/or 108 is a chassis hanger bracket. In some embodiments, the brackets 106 and 108 have different shapes and/or forms on the frame members 102. In some embodiments, the brackets 106 and 108 are composed of different materials. In some embodiments, the brackets 106 and 108 are connected to different respective frame members of the frame members 102. In some embodiments, the brackets 106 and 108 transmit loads from the components which are mounted on the chassis assembly to the structural members (e.g., the frame members 102). In some embodiments, the brackets 106 and 108 are bonded, welded, and/or press fit to the frame members 102.

In some embodiments, the chassis assembly 100 includes one or more telescopic frame members (e.g., that enable the wheelbase to be altered by either electrically powered position actuators or manual means). The ability to change the wheelbase of the vehicle allows a chassis assembly to accommodate the various chassis wheelbase lengths that conventionally require pre-built chassis wheelbase lengths (e.g., in conventional single plane vehicle chassis assemblies). In some embodiments, the chassis assembly 100 includes a load body (e.g., a container box or flatbed) to be mounted on one of the chassis planes through mechanical riveted or adhesively bonded connections. In some embodiments, the load body is composed of composite, steel, and/or aluminum structures. In some embodiments, the load body is configured to be hydraulically or pneumatically raised or lowered electronically and/or positioned by an operator (e.g., via an operator interface).

In some embodiments, a load body, box, and/or flatbed is attached to the chassis assembly 100 by one or more brackets. In some embodiments, the one or more brackets are composed of a ferrous and/or non-ferrous material. In some embodiments, the one or more brackets are attached to the surfaces of the cross members 104. In some embodiments, the one or more brackets allow conventional U-bolts to pass through mounting holes and be secured to the one or more brackets. In some circumstances this means of attachment to the chassis is superior to conventional means that allow the load body, box, and/or flatbed to translate forward and aft on the vehicle frame rails and be subjected to wear and eventual structural failure of the U-bolts or frame rails.

In some embodiments, the chassis assembly 100 is part of a vehicle and includes an axle assembly. In some embodiments, the axle assembly includes a mechanism that allows one or more tires of the vehicle to be lifted off the ground (e.g., when the vehicle load is low enough to not require a load distribution function of the respective axle assembly).

As discussed in more detail later, the frame members 102 may contain electrical power distribution unit (PDU) components, such as contactors, current sensors, CAN bus and temperature sensors (e.g., a structurally-integrated PDU system). In some embodiments, the PDU components are contained in a laminated bus bar printed circuit assembly (e.g., that slides into and out of the frame members 102).

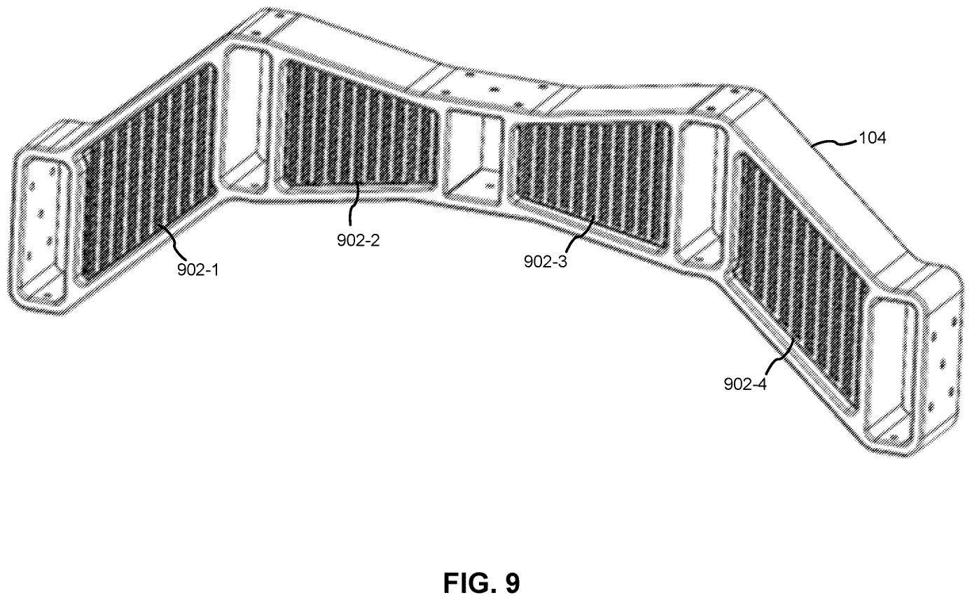

In some embodiments, the cross members 104 are designed and positioned to maintain the spatial relationship between the frame members 102 (and optionally provide a load carrying function for lateral loads and torsional resistance). In various embodiments, the cross members 104 are composed of composite pultrusion, molded composite, aluminum, steel, metal alloy, or a combination thereof. In some embodiments, the cross members 104 include a resistive heating element for use as a burn off resistor function for dissipation of electrical power (as described later with respect to FIG. 9). In some embodiments, the cross members 104 are configured to allow the frame members 102 to shift planes at any location across the length for increased utility in integration of components such as cabin or load body.

In some embodiments, the chassis assembly 100 includes a cradle module (e.g., for a suspension and/or powertrain). In some embodiments, the cradle module includes (or is configured to connect to and support) one or more of a powertrain, a suspension system, a braking system, a steering system, an actuator, one or more electronics, one or more embedded systems, and/or one or more power distribution units. In some embodiments, the cradle module is configured to move (e.g., drive itself), e.g., to align for installation. In some embodiments, the cradle module is configured to be wirelessly controlled via a communication component (e.g., a near field communication device) and/or controlled via a secure wired or wireless communication interface (e.g., a machine-to-machine communication interface).

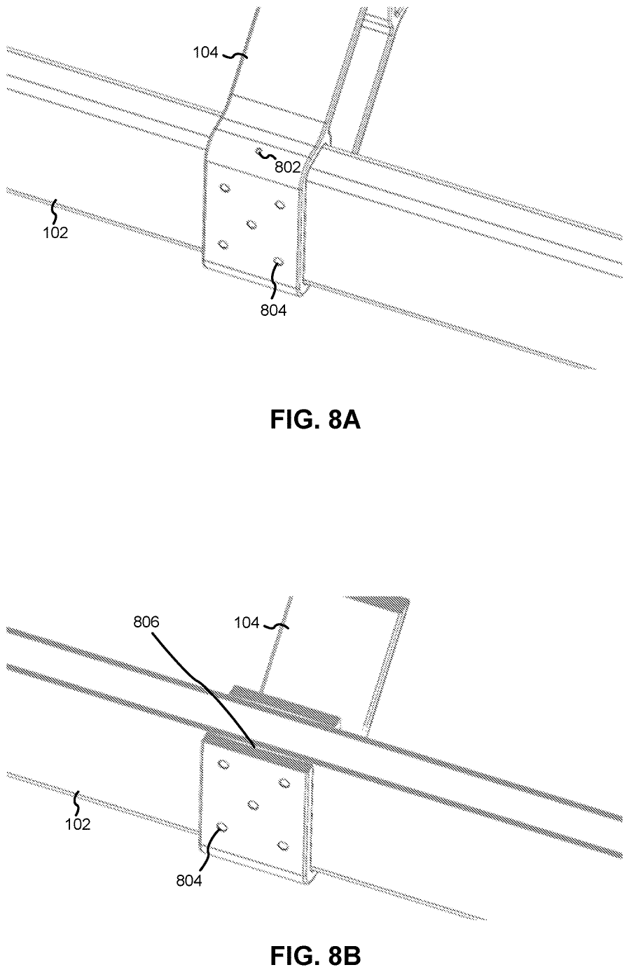

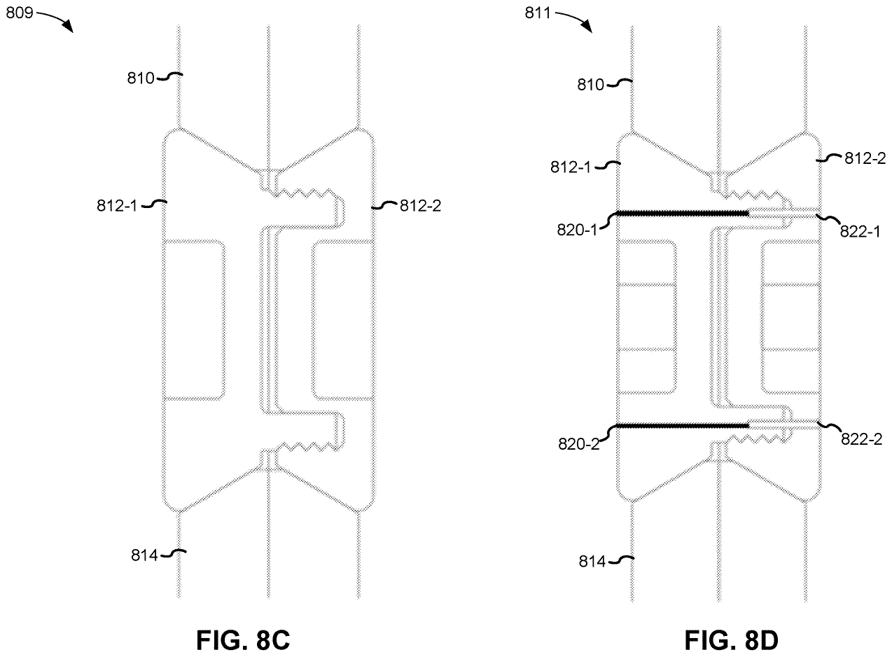

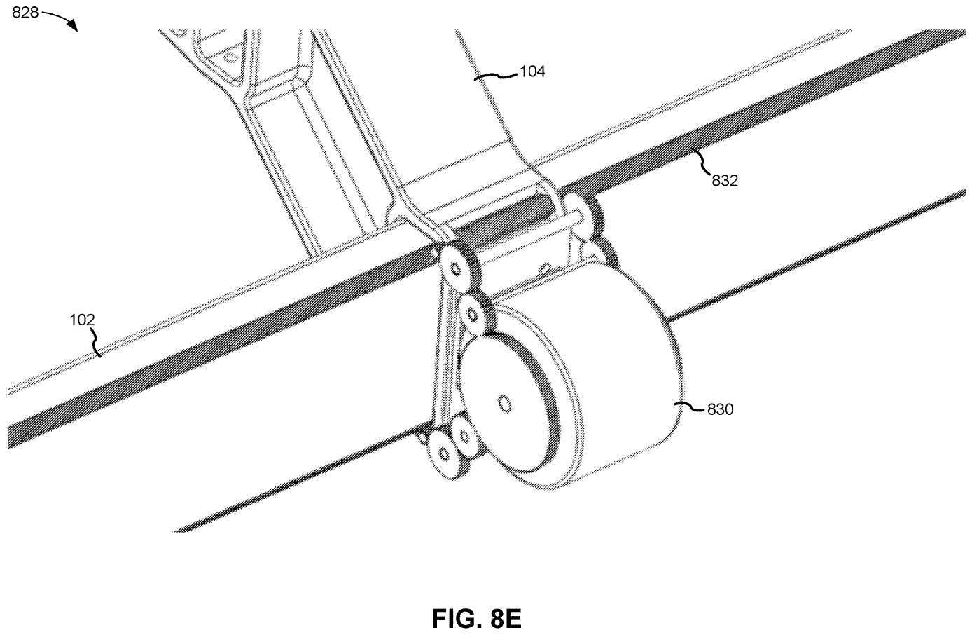

In some embodiments, the cradle module is attached to the frame members 102 with a twist-lock coupling component (e.g., that captures a hanger bracket mounted on a frame member). For example, the twist-lock coupling component is the attachment system 809 or 811 discussed later with respect to FIGS. 8C and 8D. In some embodiments, the twist-lock coupling component constrains a mounting structure of the cradle module with the hanger bracket to function as one single structural joint. In some embodiments, the twist-lock coupling component includes a safety wire, a ratcheting mechanism, or other locking mechanism that prevents the coupling component from untwisting and separating (e.g., unless intentionally and specifically configured to do so by trained and authorized personnel). In some embodiments, the twist-lock coupling component has a tapered interface (e.g., on each side of the structural members) that self-centers and precisely locates one bracket with another and distributes the load of the joint over a wider area than a conventional bolted or riveted connection. In some embodiments, one or more of the twist-lock elements are adhered to a respective assembly prior to coupling another component via the twist-lock coupling component. For example, the twist-lock elements are adhered to enable quick alignment with each other and provide quick assembly by providing sufficient shearing force to exceed the strength of the adhesion material.

In some embodiments, a tamper-resistant battery-pack attachment mechanism is twist-lock device that allows the battery pack to become interlocked with a chassis bracket (however, in some embodiments, allowing the chassis frame member to twist and/or flex relative to the battery pack while minimizing the transfer of stress and/or movement to the battery pack). In some embodiments, battery pack assemblies are located between the frame members 102 and/or outside of the frame members 102 (e.g., using chassis hanger brackets, such as the brackets 106 and/or 108). In some circumstances, the chassis assembly 100 (e.g., with pultruded frame members) provides high energy absorption in the event of a vehicle side impact therefore reducing the displacement of the battery pack assemblies.

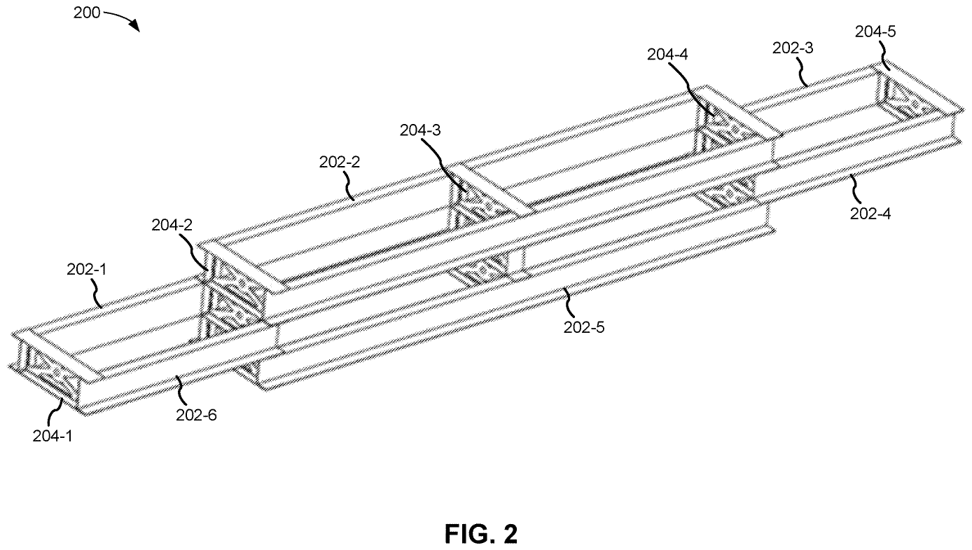

FIG. 2 illustrates a chassis assembly 200 in accordance with some embodiments. The chassis assembly 200 includes frame members 202 (e.g., frame members 202-1 through 202-6) and cross members 204 (e.g., cross members 204-1 through 204-5). In some embodiments, the chassis assembly 200 is a multi-plane metal chassis assembly. In some embodiments, the chassis assembly 200 is composed of a c-shaped cross-section, box-section steel members with c-sections, and/or box-section cross members. In some embodiments, the chassis assembly 200 includes more than two planar elements. In some embodiments, one or more of the frame members 202 are composed of metal (e.g., steel and/or aluminum). In some embodiments, one or more of the cross members 204 are composed of metal (e.g., steel and/or aluminum). In some embodiments, one or more of the frame members 202 and/or one or more of the cross members 204 (collectively the “structural members”) are connected to (e.g., lined with, coated with, layered with, or otherwise connected to) electrically-insulating material. In some embodiments, the electrically-insulating material is thermally conductive. In some embodiments, an electrically-conductive material (e.g., a bus bar) is coupled to the electrically-insulating material. In some embodiments, the electrically-conductive material is electrically-coupled to a circuit and/or controller (e.g., a printed circuit board). In some embodiments, the electrically-insulating material allows electrical signaling (via the electrically-conductive material) without causing galvanic corrosion to the frame members and preventing an electrical short between the electrically-conductive material and the metal structural members. In some embodiments, a chassis assembly includes one or more of the frame members 102, one or more of the frame members 202, one or more cross members 104, and/or one or more of the cross members 204.

In some embodiments, the chassis assembly 200 is a steel dual-plane chassis assembly. In some embodiments, the chassis assembly 200 composed of ferrous and/or non-ferrous material. In some embodiments, the chassis assembly 200 is composed of one or more foreign material fiber (e.g., distributed throughout a volume of the structural members).

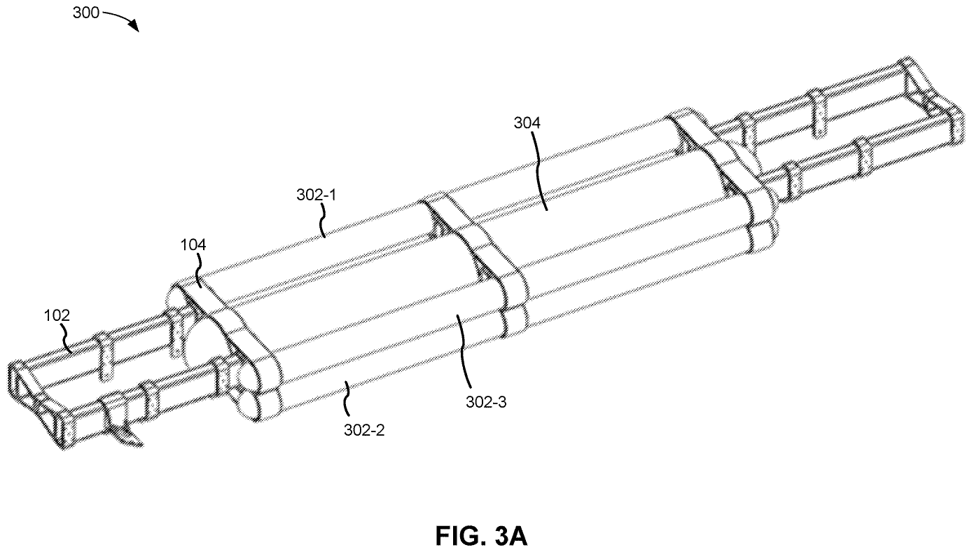

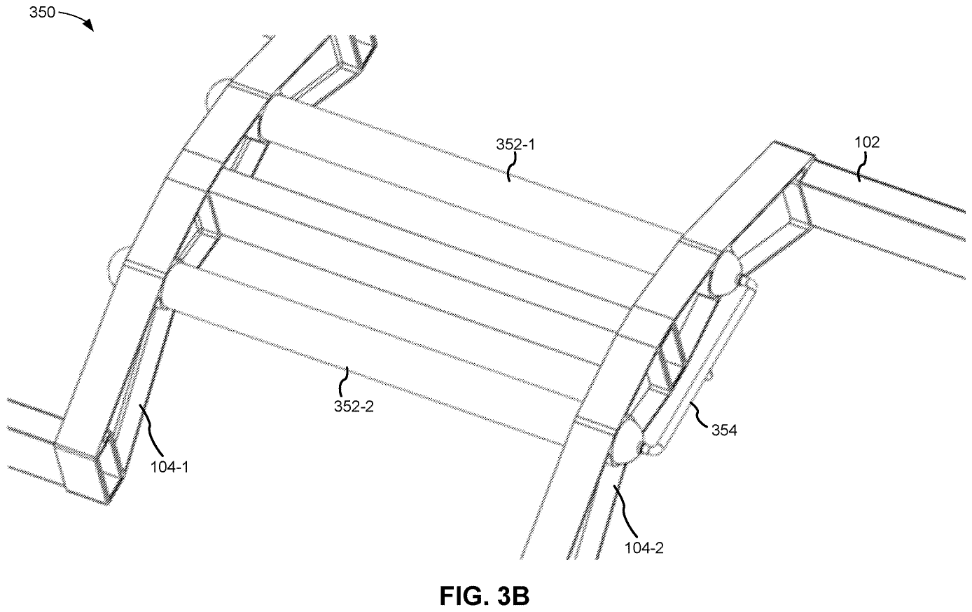

FIGS. 3A-3B illustrate example chassis assemblies with tanks in accordance with some embodiments. FIG. 3A illustrates a chassis assembly 300 that includes the frame members 102, the cross members 104, a tank 304, and tanks 302 (e.g., tanks 302-1 through 302-3). In some embodiments, the tank 304 and/or the tanks 302 (collectively “the tanks”) are composite pressure vessels (e.g., filament-wound) arranged as structural members of the chassis assembly 300. In some embodiments, one or more of the tanks contain gaseous or liquid fuel. In some embodiments, one or more of the tanks are composed of composite materials, ferrous materials, and/or non-ferrous materials. In some embodiments, the chassis assembly 300 is, or includes an integrated composite compressed hydrogen tank chassis system.

In some embodiments, the chassis assembly 300 includes an integrated composite compression tank component (e.g., a hydrogen tank component). In some embodiments, the tank 304 is a compressed hydrogen tank that serves as a structural member of the chassis assembly 300. In some embodiments, the tank 304 is composed of composite materials (e.g., ferrous, or non-ferrous materials). In some embodiments, the tank 304 includes electrical and/or electronic components. In some embodiments, the electrical and/or electronic components include a sensor array that transmits data to a vehicle management system (e.g., structural data used to determine a structural integrity of the tank 304. In some embodiments, the tank 304 contains hydrogen or other gaseous or liquid fuel sources.

FIG. 3B illustrates a chassis assembly 350 that includes the frame members 102, the cross members 104, tanks 352 (e.g., tanks 352-1 and 352-2), and a, For example, the chassis assembly 350 includes a cross member 104 with an integrated compressed air, gas, or fuel tank. In some embodiments, the tanks 352 are composite tanks (e.g., composite compressed hydrogen tanks). In some embodiments, the tanks 352 provide the chassis assembly 350 with additional stiffness (e.g., the tanks 352 are configured as integral chassis stiffeners). In some embodiments, the chassis assembly 350 further includes one or more energy storage batteries. In some embodiments, the tanks 352 are integrated with the energy storage batteries. For example, the tanks 352 and the energy storage batteries form a hybrid chassis system that incorporates both compressed hydrogen storage and energy storage batteries for vehicles that utilize the energy storage batteries for city or urban driving and then switch to a hydrogen fuel cell for long distance driving or vice versa.

In some embodiments, the tanks 352 provide structural support for the chassis assembly 350 (e.g., function as a structural frame member and/or augment the frame members 102). In some embodiments, the tank connector 354 includes an inlet (e.g., an air, gas, or fuel inlet) connected to a first tank and an outlet (e.g., an air, gas, or fuel outlet) connected to a second tank. In some embodiments, the tank connector 354 includes a pipe and/or hose. In some embodiments, the tank connector 354 includes plumbing for access to the interior volume of the tanks 352. In some embodiments, the tank connector 354 fluidically couples the tanks 352 to one another. In some embodiments, the tank connector 354 couples the tanks 352 to one or more other components (e.g., an engine or drivetrain component).

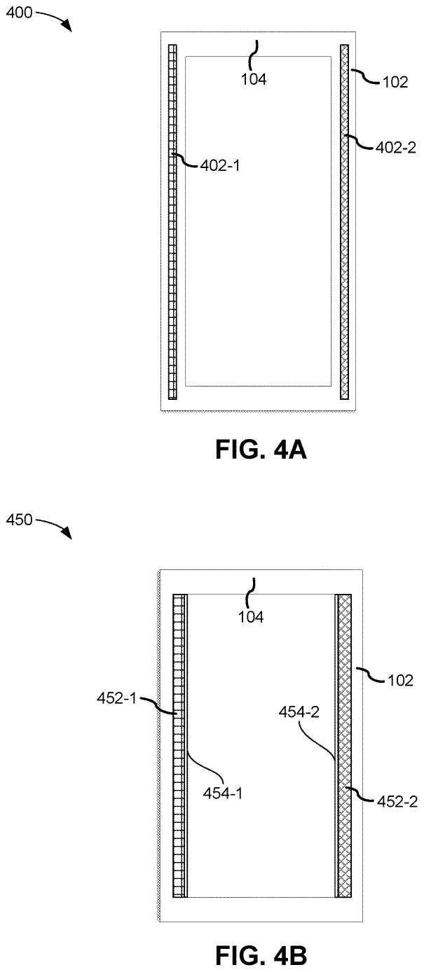

FIGS. 4A-4B illustrate example assemblies with bus bars in accordance with some embodiments. FIG. 4A illustrates a chassis assembly 400 that includes the frame members 102 and the cross members 104. The chassis assembly 400 also includes bus bars 402 (e.g., bus bars 402-1 and 402-2). In some embodiments, the bus bar 402-1 and/or 402-2 is a low voltage bus bar (e.g., connected to an electrical ground). In some embodiments, the bus bar 402-1 and/or 402-2 is a high voltage bus bar (e.g., connected to a voltage source). In some embodiments, the bus bar 402-1 and/or 402-2 is structurally embedded in a frame member. In some embodiments, the frame members 102 are electrically insulating.

FIG. 4B illustrates a chassis assembly 450 that includes the frame members 102, the cross members 104, and bus bars 452 (e.g., bus bars 452-1 and 452-2). In some embodiments, the bus bar 452-1 and/or 452-2 is a low voltage bus bar (e.g., connected to an electrical ground). In some embodiments, the bus bar 452-1 and/or 452-2 is a high voltage bus bar (e.g., connected to a voltage source). In some embodiments, the bus bar 452-1 and/or 452-2 is adhered to one or more of the frame members 102. In some embodiments, the bus bars 452 are bonded to an interior volume of the frame members 102. In some embodiments, the bus bars 452 are contained within an interior volume of the frame members 102. In some embodiments, each of the positive and negative busbars (e.g., the bus bar 452-1 and the bus bar 452-2) are insulated by respective insulating covers 454-1 and 454-2 (e.g., the insulating covers are composed of an electrically-insulating material such as a dielectric material).

In some embodiments, the bus bars 402 and/or 452 are composed of an electrically-conductive material. In some embodiments, the bus bars 402 and/or 452 are composed of integral electrically-conductive material. In some embodiments, the electrically-conductive material is inserted into the pultrusion process before the structural shape becomes rigid.

In some embodiments, the electrically-conductive material is mechanically or adhesively bonded to the inside or outside of a frame member or cross member. In some embodiments, the bus bars 402 and/or 452 are connected to a backbone structure of the chassis assembly. In some embodiments, the bus bars 402 and/or 452 are effectively laminated. In some embodiments, the bus bars 402 and/or 452 are composed of a non-ferrous material such as copper or aluminum. In some embodiments, the bus bars 402 and/or 452 are composed of an electrically-conductive fiber, e.g., that is interlaced with the fibers of a pultruded structural member. In some embodiments, the bus bars 402 and/or 452 include a laminated bus bar assembly and/or a printed circuit board.

In some embodiments, one or more of the bus bars 402 and/or 452 are high voltage bus bars. In some circumstances, the placement of a high voltage bus bar in the chassis plane backbone frame member (e.g., the upper backbone frame member) has the purpose of minimizing exposure to the high voltage bus bar in the event of a vehicular collision that may or may not breach the outer frame members and encroach upon the backbone (center) frame member. In some circumstances, the high voltage bus bar being located inside the chassis plane backbone frame member allows for high voltage power distribution unit (PDU) components to be located inside the frame member, thereby serving as an integrated (dual purpose) PDU housing.

In some embodiments, one or more of the bus bars 402 and/or 452 are low voltage bus bars. In some embodiments, the low voltage bus bar(s) are located in one or more outer (e.g., lateral) frame members. In some embodiments, the low voltage bus bar(s) are located in front section and/or rear section frame members. In some embodiments, the low voltage bus bar(s) are co-located with one or more high voltage bus bars (e.g., in an upper chassis plane backbone frame member).

In some embodiments, the bus bars described herein are composed of non-ferrous materials and/or electrically-conductive composite fibers. In some embodiments, the frame members described herein are electrically conductive. In some embodiments, the bus bars are enclosed (e.g., wrapped, coated, or layered) in an electrically-insulative material (e.g., prior to being embedded in a frame member). In some embodiments, a first bus bar functions as a negative electrical potential carrier and a second bus bar functions as a positive electrical potential carrier (e.g., enabling a closed electrical circuit function when coupled to an electrical load). In some embodiments, the electrical load is internal to a frame member.

In some embodiments, a bus bar is a single component, while in other embodiments, the bus bar is composed of multiple components joined together (e.g., in various methods) to form a singular bus bar component. In some embodiments, a bus bar functions as a resistive element (e.g., that selectively transmits heat generated within its volume to a frame member of the frame members 102).

In some embodiments, a vehicle chassis assembly includes one or more of the chassis assembly 100, the chassis assembly 200, the chassis assembly 300, the chassis assembly 350, the chassis assembly 400, and the chassis assembly 450.

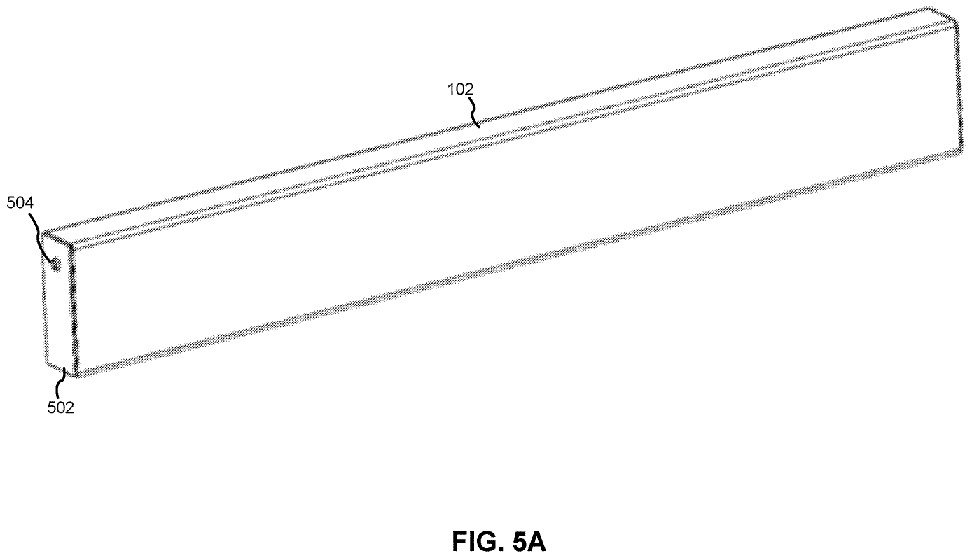

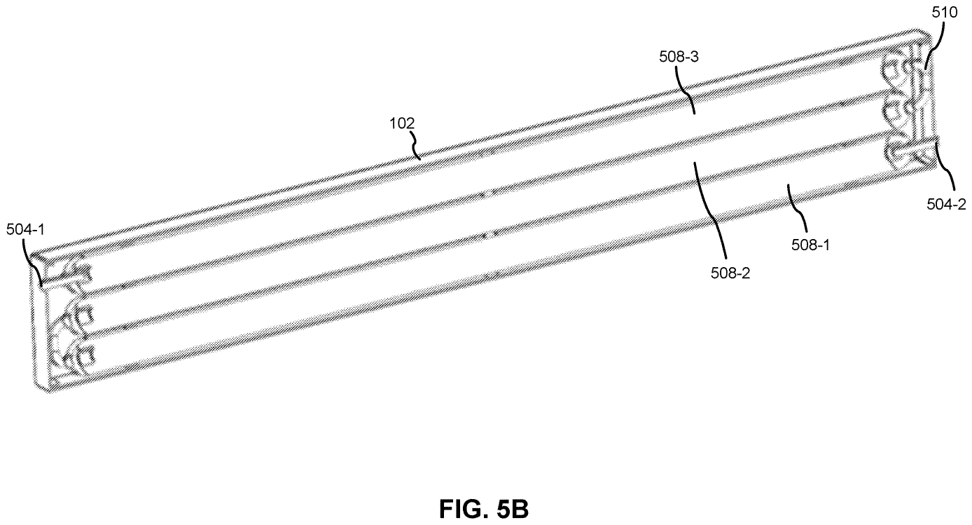

FIGS. 5A-5B illustrate an example frame member in accordance with some embodiments. FIG. 5A shows a frame member 102 that includes an end plate 502 and a connector 504. In some embodiments, the frame member 102 in FIG. 5A includes an integrated air, gas, or fuel tank. In some embodiments, the frame member 102 in FIG. 5A includes an integrated hydraulic accumulator assembly. In some embodiments, the frame member 102 in FIG. 5A includes multiple internal components (e.g., tanks, couplers, and/or electrical components). In some embodiments, the connector 504 is configured to couple an internal component (e.g., a tank) with an external component (e.g., a different frame member). In some embodiments, one or more pneumatic and/or electrical components are arranged inside of a frame member 102.

FIG. 5B shows a frame member 102 that includes interior tanks 508 (e.g., tank 508-1 through 508-3) and connectors 504-1 and 504-2. The interior tanks 508 are coupled to one another via a connector 510 (e.g., an internal connector). In some embodiments, the interior tanks 508 are fluidically coupled to one another in a series configuration. In some embodiments, the interior tanks 508 are fluidically coupled to one another in a parallel configuration. In some embodiments, the interior tanks 508 are not fluidically coupled to one another. In some embodiments, the frame member 102 includes more or less interior tanks 508 than are shown in FIG. 5B. In some embodiments, the interior tanks 508 include one or more air, gas, or fuel tanks. In some embodiments, the frame member 102 includes a hydraulic accumulator assembly. In some embodiments, the connectors 504 are connected to the interior tanks 508. In some embodiments, the interior tanks 508 are coupled to different external components (e.g., via different respective connectors). In some embodiments, the interior tanks 508 are structural load bearing components (e.g., that augment the load carrying capacity of the frame member 102).

In some embodiments, the frame member 102 includes one or more compressed air tanks and/or hydraulic tanks. In some embodiments, the frame member 102 is shaped to function as a fluidic tank (e.g., by capping and/or sealing the ends of the frame member). In some embodiments, the frame member 102 functions as a fuel container (e.g., for an oil-based fuel and/or a low-pressure fuel). In some embodiments, the frame member 102 contains gasoline, diesel, and/or other bio-derived liquid fuels.

In some embodiments, the interior tanks 508 function as a chassis stiffener system. In some embodiments, the interior tanks 508 provide torque and/or bend resistance for the frame member 102. In some embodiments, the frame member 102 reduces the torsional loads and bending loads on the interior tanks 508. In some embodiments, the interior tanks 508 are composed of aluminum. In some embodiments, the interior tanks 508 are composed of a core material that is covered (e.g., wrapped) with composite fibers (e.g., creating a hybrid material tank structure).

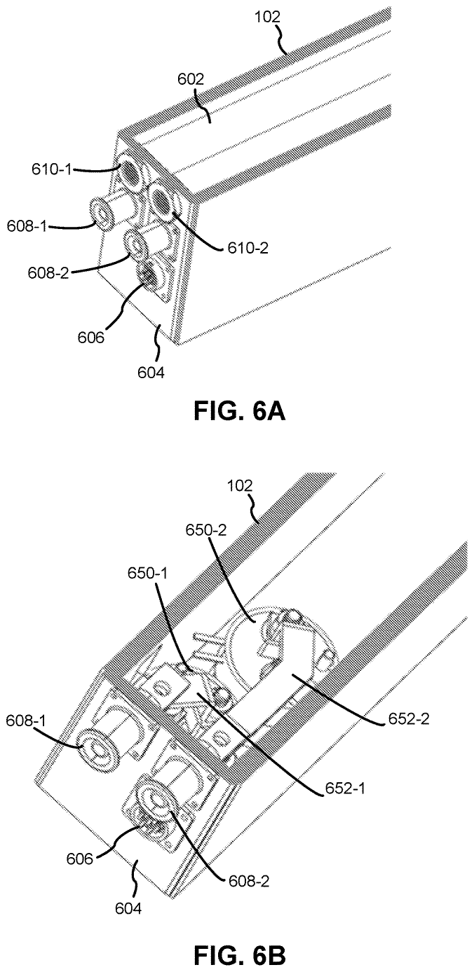

FIGS. 6A-6B illustrate example frame members with connector components in accordance with some embodiments. FIG. 6A illustrates a frame member 102 that includes an interior connector 602 (e.g., a hose or pipe) and an end plate 604. The end plate 604 in FIG. 6A includes connectors 610-1 and 610-2 (e.g., fluidic connectors), connectors 608-1 and 608-2 (e.g., electrical connectors), and connector 606 (e.g., an electronic connector). The interior connector 602 is connected to the connector 610-1 in FIG. 6A. In some embodiments, the connectors 608 are coupled to one or more bus bars in an interior of the frame member 102. In some embodiments, the connector 606 is coupled to an electronic component in an interior of the frame member 102. In some embodiments, the frame member 102 in FIG. 6A is a high voltage PDU frame member. For example, the frame member 102 in FIG. 6A includes interior piping (e.g., the interior connector 602), piping bulkhead connectors (e.g., the connectors 610), power connectors (e.g., the connectors 608), and a communications bulkhead connector (e.g., the connector 606). In some embodiments, two or more of the connectors 606, 608, and/or 610 are incorporated into a multiplex connector (e.g., rather than being discrete connectors). In some embodiments, one or more of the connectors 606, 608, and/or 610 are located on a different side of the frame member 102 (e.g., a top side, bottom side, or lateral side of the frame member). In some embodiments, one or more of the connectors 606, 608, and 610 are unused (e.g., and optionally capped).

FIG. 6B illustrates a frame member 102 that includes electrical contactors 650-1 and 650-2, bus bars 652-1 and 652-2, and the end plate 604. The end plate 604 includes the connectors 608-1 and 608-2 and the connector 606. In FIG. 6B, the electrical contactors 650 are electrically connected to the bus bars 652 and the bus bars 652 are electrically connected to the connectors 608. The bus bars 652 may be instances of any of the bus bars described herein. In some embodiments, the frame member 102 in FIG. 6B is a high voltage PDU frame member. In some embodiments, the frame member 102 includes one or more additional internal power and/or electronic components not shown in FIG. 6B. In some embodiments, the electrical contactors 650 are controller area network (CAN) controlled contactors. In some embodiments, the electrical contactors 650 are coupled to the bus bars 652 via one or more tabs (e.g., one or more tabs that are punched or formed to make electrical contact with respective terminals of the electrical contactors). In some embodiments, the electrical contactors 650 are selectively coupled to the bus bars 652 (e.g., based on one or more external signals and/or one or more local sensor signals). In some embodiments, the electrical contactors 650 are electrical switches.

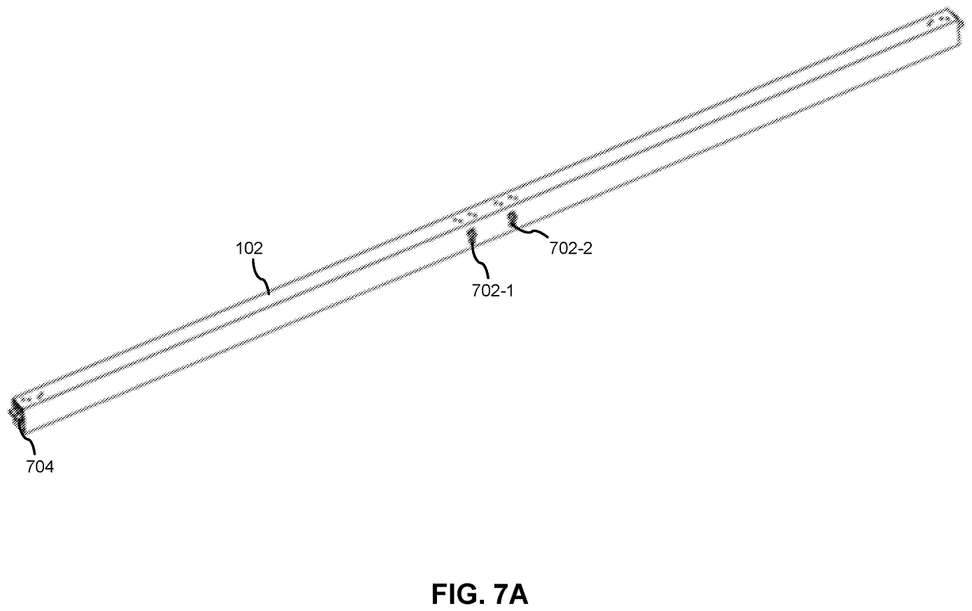

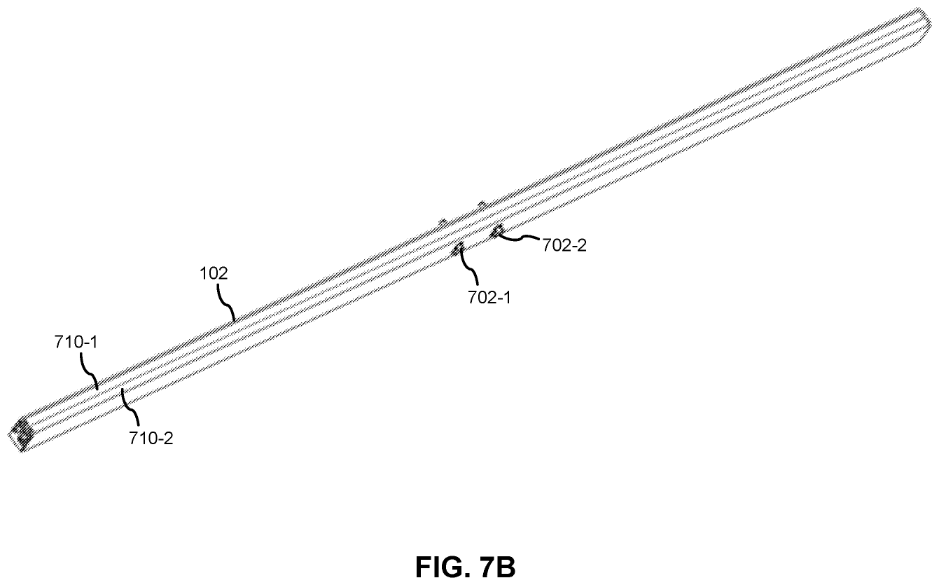

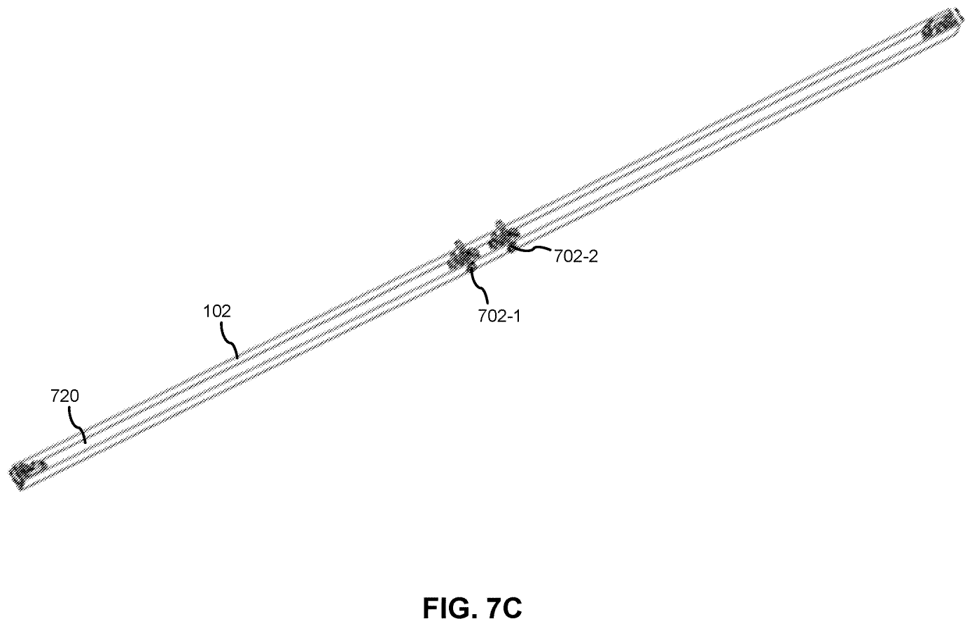

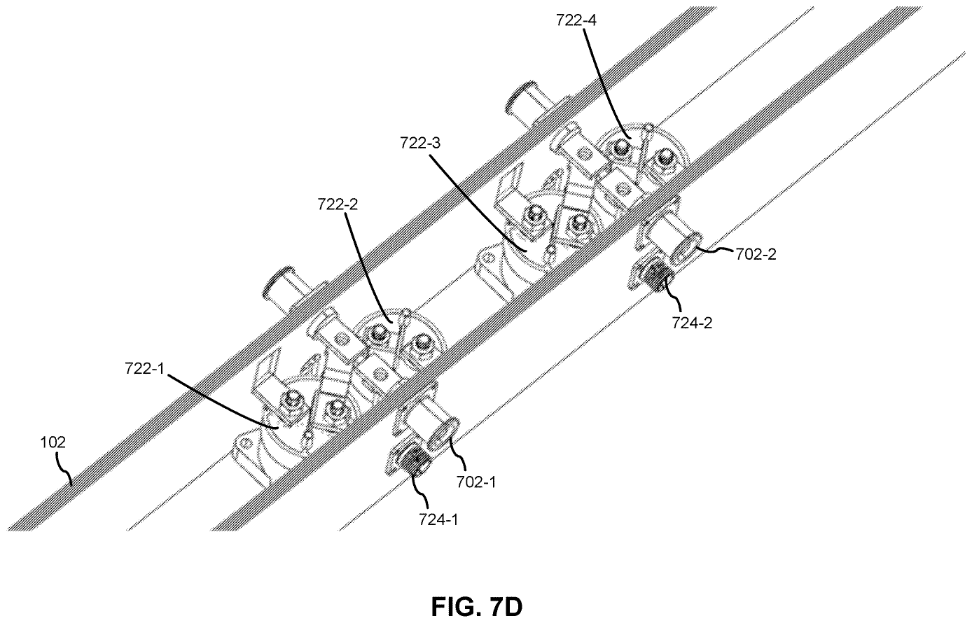

FIGS. 7A-7D illustrate example frame members with connector components in accordance with some embodiments. FIG. 7A illustrates a frame member 102 that includes an end connector 704 and lateral connectors 702-1 and 702-2. In some embodiments, the end connector 704 is arranged on an end plate of the frame member 102. The end connector 704 may be any of the connectors in the end plate 604, described previously with respect to FIGS. 6A and 6B. In some embodiments, the end connector 704 connects to a connector on a different frame member 102. In some embodiments, the lateral connectors 702 are electrical connectors and/or fluidic connectors. In some embodiments, the lateral connectors 702 connect to corresponding connectors on a cross member 104. In some embodiments, the frame member 102 in FIG. 7A is a high voltage PDU frame member. In some embodiments, the frame member 102 includes one or more power electronic components, bus bars, cables, pipes, accumulators, sensors, pneumatics and/or connectors (e.g., the lateral connectors 702 and the end connector 704).

FIG. 7B illustrates an interior view of the frame member 102 from FIG. 7A. The frame member 102 includes interior connectors 710-1 and 710-2 (e.g., pipes or hoses) and the lateral connectors 702-1 and 702-2. In some embodiments, the interior connectors 710 are connected to the connectors 610 shown in FIG. 6A. In some embodiments, the interior connectors 710 are components of a pneumatic, hydraulic, or other fluidic system. In some circumstances, the interior connectors 710 provide structural support for the frame member 102. In some embodiments, the interior connectors 710 are thermally-conductive (e.g., provide temperature distribution). In some embodiments, the interior connectors 710 are coupled to one or more heating or cooling elements. In some embodiments, the interior connectors 710 are composed of a composite material, a ferrous material, and/or a non-ferrous material.

FIG. 7C illustrates a frame member 102 that includes the lateral connectors 702 and an interior bus bar 720. In some embodiments, the interior bus bar 720 is arranged adjacent to (e.g., below) the interior connectors 710 shown in FIG. 7B. In some embodiments, the interior bus bar 720 is connected to one of the connectors 608 shown in FIG. 6A. In some embodiments, the frame member 102 in FIG. 7C is a high voltage PDU frame member. In some embodiments, the interior bus bar 720 is connected to the lateral connectors 702 (e.g., via one or more electrical contactors).

FIG. 7D illustrates a frame member 102 that includes electrical contactors 722 (e.g., 722-1 through 722-4), the lateral connectors 702, and connectors 724-1 and 724-2. In some embodiments, the electrical contactors 722 are CAN-controlled contactors. In some embodiments, the contactors 722 are coupled to one or more bus bars (e.g., the interior bus bar 720) and the lateral connectors 702. In some embodiments, the contactors 722 are configured to selectively electrically couple the bus bar(s) to respective lateral connectors of the lateral connectors 702. In some embodiments, the connectors 724 are connected to a communications bus in the frame member 102. In some embodiments, the frame member 102 in FIG. 7C is a high voltage PDU frame member. In some embodiments, the electrical contactors 722 are connected to one or more structurally-integrated bus bar(s).

FIGS. 8A-8B illustrate example joint systems in accordance with some embodiments. FIG. 8A illustrates a physical coupling (e.g., a joint) between a frame member 102 and a cross member 104. FIG. 8B illustrates a cross-sectional view of the coupling between the frame member 102 and the cross member 104 shown in FIG. 8A. The cross member 104 in FIGS. 8A and 8B includes a joint structure that encircles a portion of the frame member 102. The joint structure shown in FIG. 8A includes an injection port 802 and a plurality of vent ports 804. In some embodiments, the joint structure of the cross member 104 is shaped to allow the frame member 102 to slide through the joint structure in the absence of an adhesive. The injection port 802 allows an adhesive to be injected into a space 806 between the cross member 104 and the frame member 102. The presence of the adhesive in the space 806 prevents the frame member 102 from sliding through the joint structure of the cross member 104. Thus, the frame member 102 may be moved into position with respect to the cross member 104 and then adhered in place by an adhesive. In some embodiments, the physical coupling is an adhesive captive joint coupling. In some embodiments, the space 806 is an internal fluid volume between the external circumference of the frame member 102 and in interior surface of the joint structure of the cross member 104. In some embodiments, an adhesive in the space 806 structurally bonds the cross member 104 to the frame member 102.

In some embodiments, a chassis assembly (e.g., any of the chassis assemblies described previously) includes one or more mechanical attachment joints. The mechanical attachment joints may be slid onto the frame members during an assembly process. Once the mechanical attachment joints are in place (e.g., in a clam shell like configuration), a two-part polymer adhesive is injected into a cavity (e.g., the space 806) between the mechanical attachment joint and the frame rail in a predetermined volume that substantially fills the cavity. In some embodiments, the adhesive does not flow beyond the extents of the mechanical attachment joint due to the shape of the cavity and the dimensional tolerances of the mechanical attachment joint relative to the frame member. Once the two-part polymer adhesive cures, the mechanical attachment joint and the frame rail become a single cohesive assembly (e.g., that transfers and distributes the load of the mechanical attachment joint to the frame member).

FIGS. 8C-8D illustrate example attachment systems in accordance with some embodiments. FIG. 8C illustrates an attachment system 809 that includes a bracket 810 connected to an attachment bracket 814 via a two-part fastener 812 (e.g., fastener components 812-1 and 812-2). In some embodiments, the attachment bracket 814 is a component of a cradle module (e.g., a drivetrain cradle module). FIG. 8D illustrates an attachment system 811 that includes the bracket 810 connected to the attachment bracket 814 via the two-part fastener 812. In the example of FIG. 8D, the two-part fastener 812 includes shear pins 820-1 and 820-2 and corresponding cavities 822-1 and 822-2.

In some embodiments, the two-part fastener 812 is a suspension and/or drivetrain cradle attachment system. In some embodiments, the two-part fastener 812 distributes a structural load between the attachment bracket 814 and the bracket 810. In some embodiments, the two-part fastener 812 is an interlocking two-part fastener. In some embodiments, the two-part fastener 812 includes a tapered lock interface (e.g., to enable self-alignment between the bracket 810 and the attachment bracket 814). In some circumstances, the tapered lock interface (e.g., a 30-degree angle taper) distributes the structural load over a larger surface area than conventional bolted connections. In some embodiments, the two-part fastener 812 includes a locking mechanism. In some embodiments, the locking mechanism includes the shear pins 820 (e.g., roll pins) and the cavities 822 shown in FIG. 8D. In some circumstances, the attachment system 809 (e.g., the two-part fastener 812) provides more surface area for distributing load, better alignment, and/or less protrusion than conventional fasteners. In some embodiments, the attachment system 809 is used to secure one or more batteries to the chassis assembly (e.g., for quick change battery access).

FIG. 8E illustrates a joint system 828 (e.g., an adjustable joint system) in accordance with some embodiments. The joint system 828 includes drive component 830 and an interface 832 on a frame member 102. The drive component 830 is connected to the cross member 104. In some embodiments, the drive component 830 is a servo drive component. In some embodiments, the interface 832 is screw-thread interface. In some embodiments, the joint system 828 translates the torque of the drive component 830 into linear movement of the cross member 104 on the frame member 102. In some embodiments, the interface 832 includes equally-spaced serrations on an edge of the frame member 102.

In some embodiments, a chassis assembly (e.g., any of the chassis assemblies described herein) includes one or more joint systems 828 for coupling a cradle module (e.g., a suspension and/or drivetrain cradle module) to the chassis assembly. In some embodiments, the cradle module includes one or more attachment brackets (e.g., the attachment bracket 814) that are relocatable from an initial position (e.g., to enable the wheelbase distance of the vehicle axle to be changed for various operational requirements). In some embodiments, the attachment brackets utilize electrically-powered position actuators to move (relocate) the attachment brackets.

FIG. 9 illustrates a cross member 104 having integrated heat elements 902 in accordance with some embodiments. In some embodiments, the integrated heat elements 902 (e.g., 902-1 through 902-4) are coupled to an electrical system of a vehicle (e.g., via one or more bus bars, such as the bus bars described herein). In some embodiments, the integrated heat elements 902 are coupled to one or more bus bars via one or more electrical contactors (e.g., the electrical contactors 650). In some embodiments, the integrated heat elements 902 are electrical resistors. In some embodiments, the integrated heat elements 902 are electrically coupled to one or more battery components via one or more electrical switches and convert electrical energy to heat.

In the event of a collision, or in cases of maintenance where the power from the battery pack must be dissipated quickly, the frame members 102 and/or cross members 104 may have integrated electrical burn off elements (e.g., the integrated heat elements 902) that can be utilized to convert power from a battery pack into heat that can be dissipated into the environment.

In some embodiments, the integrated heat elements 902 are heat exchangers. In some embodiments, the heat exchangers are thermally coupled to a liquid cooling system (e.g., a cooling system of a powertrain component) to dissipate heat from the liquid cooling system to the ambient environment. In some embodiments, the integrated heat elements 902 include refrigerated cooler elements and/or electrical heater elements, e.g., that are able to selectively cool down or warm up a liquid of the cooling system as desired.

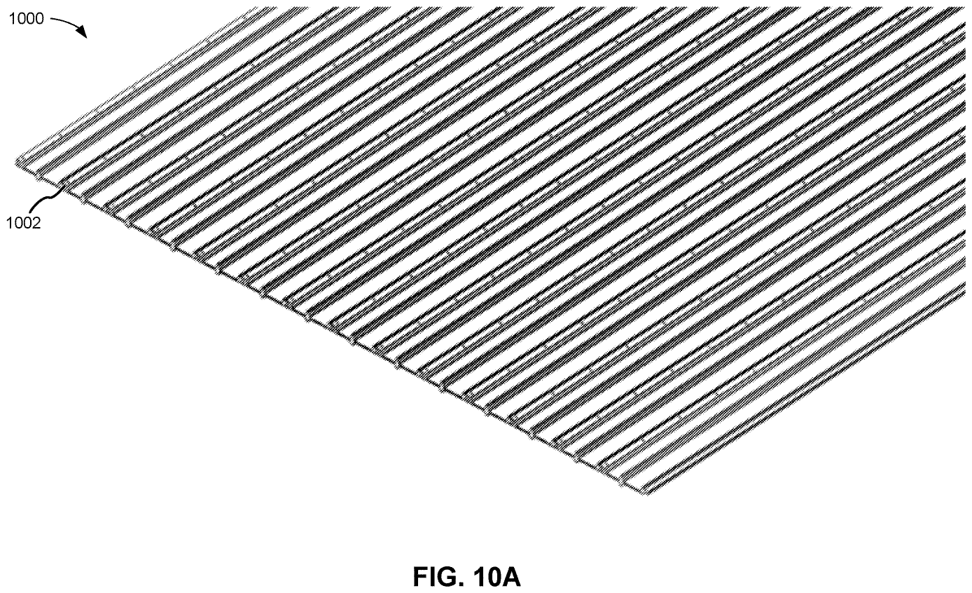

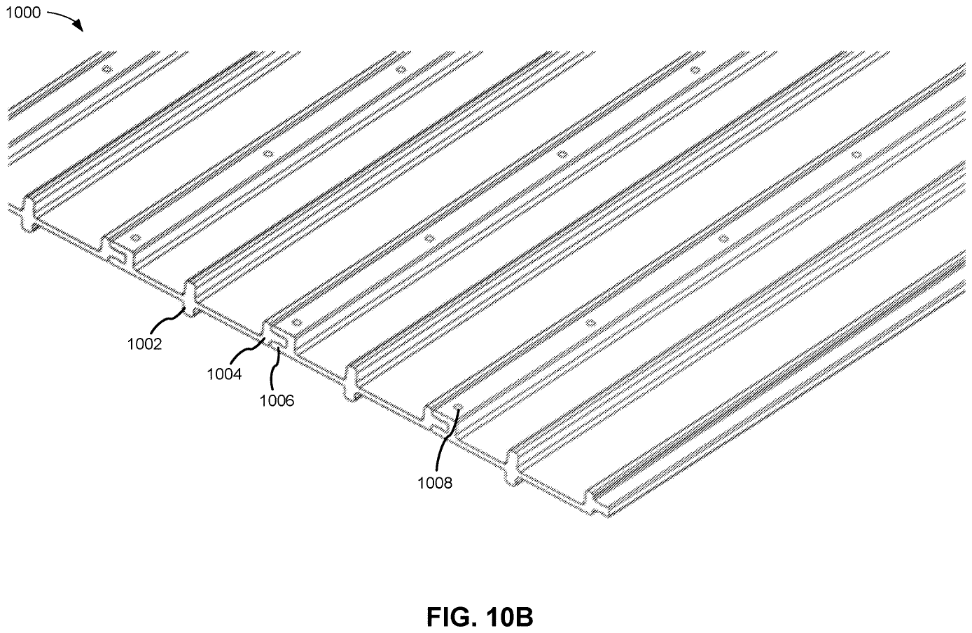

FIGS. 10A-10B illustrate a belly pan assembly 1000 in accordance with some embodiments. In some embodiments, the belly pan assembly 1000 is modular. In some embodiments, the belly pan assembly 1000 is a structural component of a chassis assembly (e.g., any of the chassis assemblies described herein). In some circumstances, the belly pan assembly 1000 improves an aerodynamic element of the chassis assembly and/or a vehicle that includes the chassis assembly. In some circumstances, the belly pan assembly 1000 functions as a penetration-resistant shield for one or more battery pack assemblies (e.g., located above the belly pan assembly 1000). In some embodiments, the belly pan assembly 1000 is composed of multiple discrete pultrusions or extrusions. In some embodiments, the belly pan assembly 1000 is composed of composite materials, ferrous materials, and/or non-ferrous materials. In some embodiments, the discrete pultrusions or extrusions contain closed volumes (e.g., that serve as cooling and/or heating channels for a thermal fluid medium). In some embodiments, the thermal fluid medium transmits the heat or cold to or from one or more energy storage batteries in thermal contact with the belly pan assembly 1000. In some embodiments, the belly pan assembly 1000 is attached (e.g., bolted) to the chassis assembly (e.g., via the brackets 108).

FIG. 10B illustrates the belly pan assembly 1000 including pultrusions 1002, 1004, and 1006. In some embodiments, the belly pan assembly 1000 includes one or more extrusions (e.g., in addition to, or in place of, the pultrusions 1002, 1004, and 1006). The pultrusion 1004 is interlocked with the pultrusion 1006 in FIG. 10B. The belly pan assembly 1000 includes an interlocking feature 1008. In some embodiments, the interlocking feature 1008 includes a mechanical fastener, a weld, and/or an adhesive connection. In some embodiments, the interlocking feature 1008 is composed of a same material as the pultrusions 1002. In some embodiments, the belly pan assembly 1000 includes one or more thermal cooling and/or heating channels (e.g., within one or more of the pultrusions).

In some embodiments, the belly pan assembly 1000 is coupled to a bottom of a chassis assembly (e.g., any of the chassis assemblies described herein). In some embodiments, the belly pan assembly 1000 is composed of a single piece of material. In some embodiments, the belly pan assembly 1000 is composed of a composite material. In some embodiments, the belly pan assembly 1000 is composed of a series of extruded sections that interlock with one another to form a single unitary piece. In some circumstances, the belly pan assembly 1000 functions as an aerodynamic aid to decrease the aerodynamic drag on a vehicle. In some circumstances, the belly pan assembly 1000 serves as an intrusion barrier for one or more battery packs, compressed fuel tanks, and/or other energy storage systems (e.g., that may be located on the opposite side of the belly pan assembly from the ground).

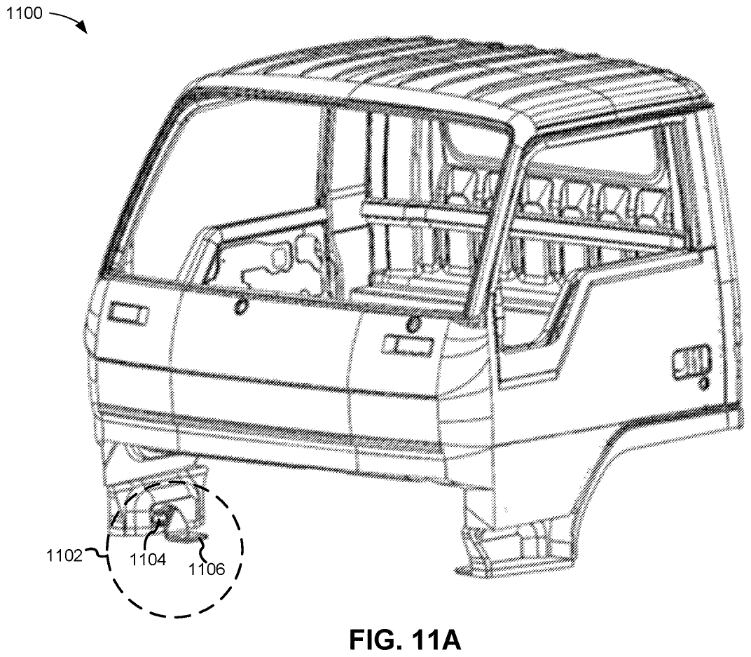

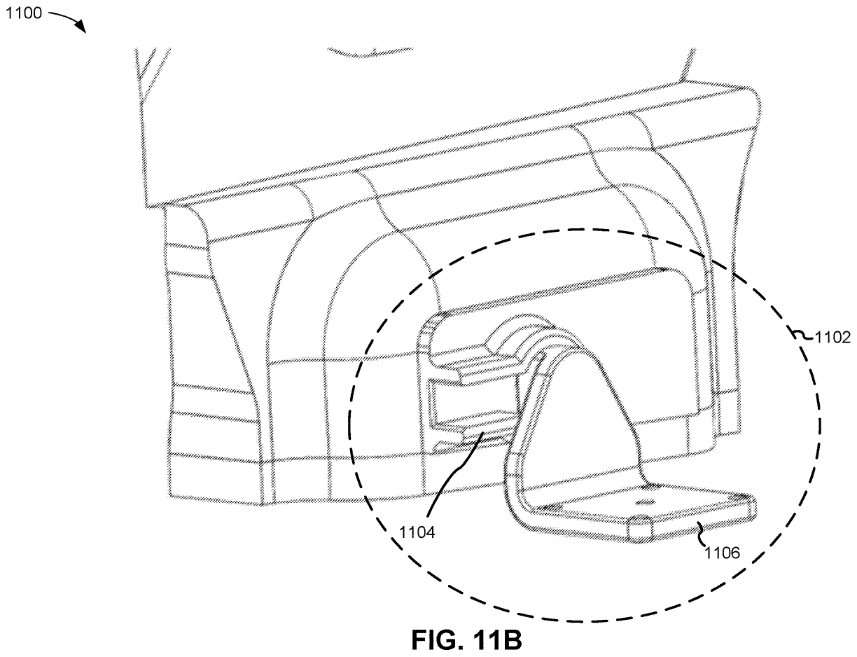

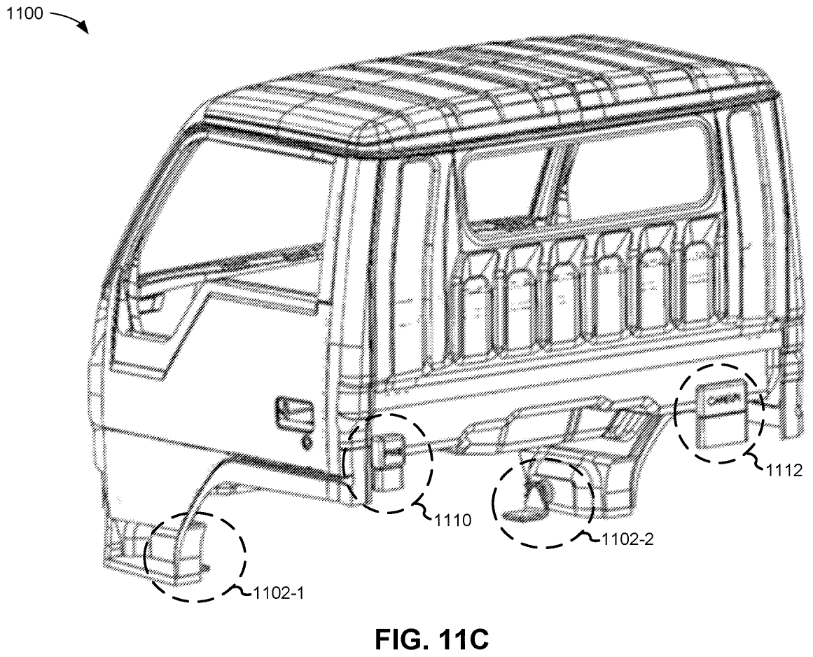

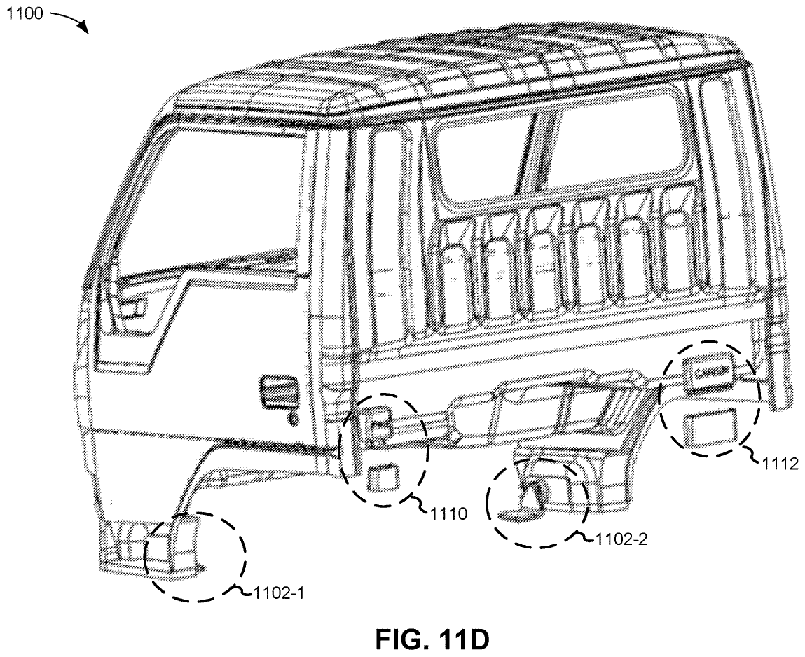

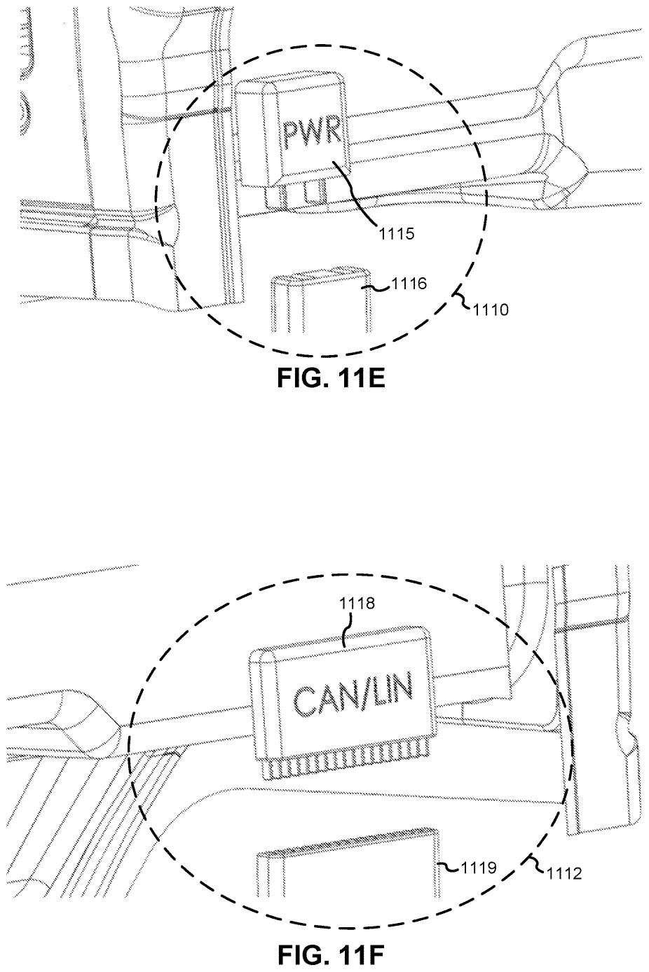

FIGS. 11A-11F illustrate a cab assembly 1100 in accordance with some embodiments. The cab assembly 1100 includes a connection component 1102. The connection component 1102 includes a pivot joint receiver 1104 and a pivot bracket 1106. FIG. 11B shows a detailed view of the connection component 1102. FIGS. 11C and 11D illustrate the cab assembly 1100 with connection components 1102-1 and 1102-2, a power component 1110, and a communications component 1112. The power component 1110 includes a cab connector 1115 and a vehicle assembly connector 1116 that are connected in FIG. 11C and disconnected in FIG. 11D. The communications component 1112 includes a cab connector 1118 and a vehicle assembly connector 1119 that are connected in FIG. 11C and disconnected in FIG. 11D. FIG. 11E illustrates a detailed view of the power component 1110. FIG. 11F illustrates a detailed view of the communications component 1112.

In some embodiments, the cab assembly 1100 is a removable plug-in cab assembly. In some embodiments, the cab assembly 1100 includes an energy storage battery (e.g., an integral storage battery). In some embodiments, the cab assembly 1100 is connected to a chassis assembly via the connection component 1102. In some embodiments, the connection component 1102 is a structural hinge pivot assembly.

In some embodiments, the connection component 1102 includes at least one pivot joint receiver (e.g., mounted on the cab) and a pivot bracket (e.g., mounted on a vehicle chassis assembly). In some embodiments, the connection component 1102 is configured so that if the cab assembly 1100 is rotated to a specific angle with respect to the pivot bracket, then the cab assembly 1100 is removable from the vehicle chassis assembly. For example, at a particular angle, the pivot bracket 1106 is removable from the pivot joint receiver 1104. In this way, the cab assembly 1100 may be separated from the vehicle chassis assembly (e.g., out the need to manually disconnect any other fasteners).

In some embodiments, the power component 1110 includes a power interface. In some embodiments, the power component 1110 is a plug-and-play component. In some embodiments, the cab connector 1115 is mounted on the cab assembly 1100. In some embodiments, the vehicle assembly connector 1116 is mounted on a vehicle chassis assembly. In some embodiments, the cab connector 1115 is positioned on the cab assembly 1100 and configured to electrically couple to the vehicle assembly connector 1116 when the cab assembly 1100 is rotated into a locked position via the connection component 1102. In some embodiments, the communications component 1112 includes a communications interface. In some embodiments, the communications component 1112 is a plug-and-play component. In some embodiments, the cab connector 1118 is mounted on the cab assembly 1100. In some embodiments, the vehicle assembly connector 1119 is mounted on a vehicle chassis assembly. In some embodiments, the cab connector 1118 is positioned on the cab assembly 1100 and configured to electrically couple to the vehicle assembly connector 1119 when the cab assembly 1100 is rotated into a locked position via the connection component 1102. For example, contacts of the cab-mounted power connector and the cab-mounted communications connector are configured and positioned so that the electrical connections are completed as the cab assembly is rotated downwards into its fixed location with respect to the vehicle chassis.

In some embodiments, the cab assembly 1100 is a modular plug-and-play assembly. In some embodiments, the cab assembly 1100 is connected to a vehicle chassis assembly (e.g., any of the chassis assemblies described herein) via connection component 1102. In some embodiments, the pivot bracket 1106 is attached to the vehicle chassis assembly (e.g., via one of the brackets described herein). In some embodiments, the cab assembly 1100 receives operational power from the vehicle chassis assembly (e.g., via the power component 1110). In some embodiments, the cab assembly 1100 receives operating information from the vehicle chassis assembly and/or sends operating instructions to the vehicle chassis assembly (e.g., via the communications component 1112). In some embodiments, the vehicle chassis assembly is configured (e.g., includes necessary components) to operate with or without the cab assembly 1100.

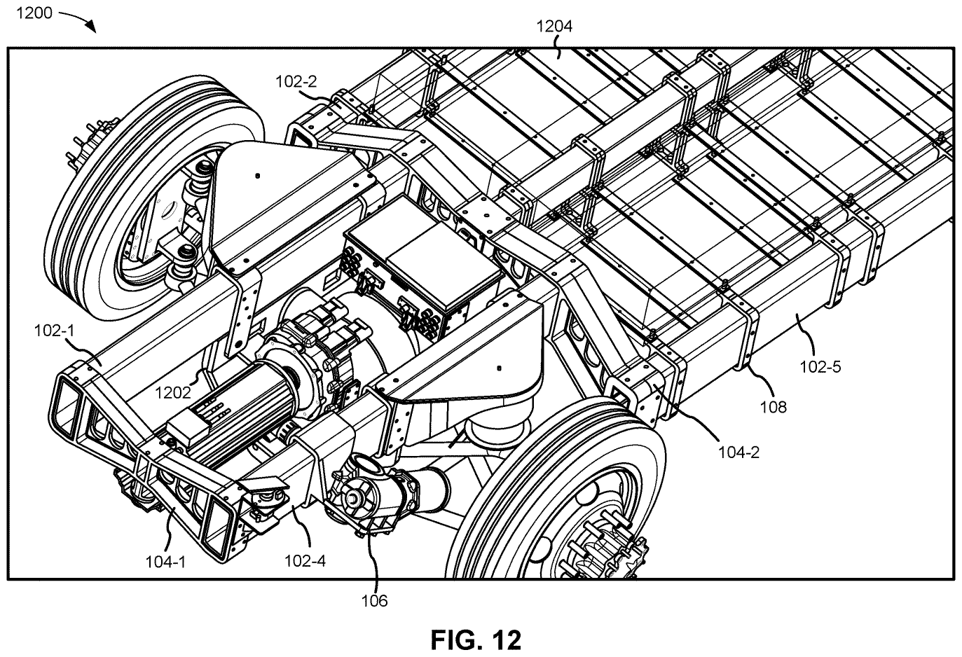

FIG. 12 illustrates a chassis assembly 1200 in accordance with some embodiments. The chassis assembly 1200 includes the frame members 102, the cross members 104, and the brackets 106 and 108. The chassis assembly 1200 also includes a cradle module 1202 and a belly pan assembly 1204. In some embodiments, the belly pan assembly 1204 is an instance of the belly pan assembly 1000.

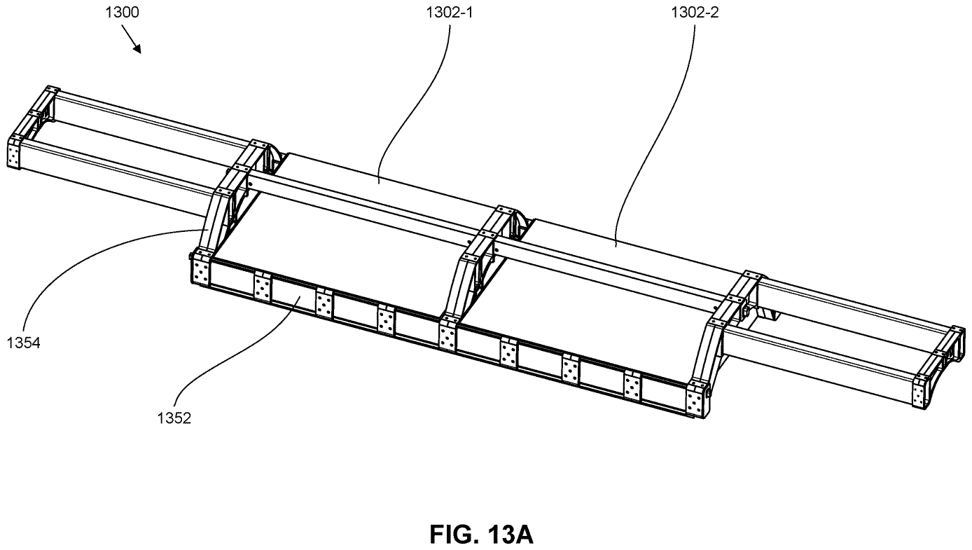

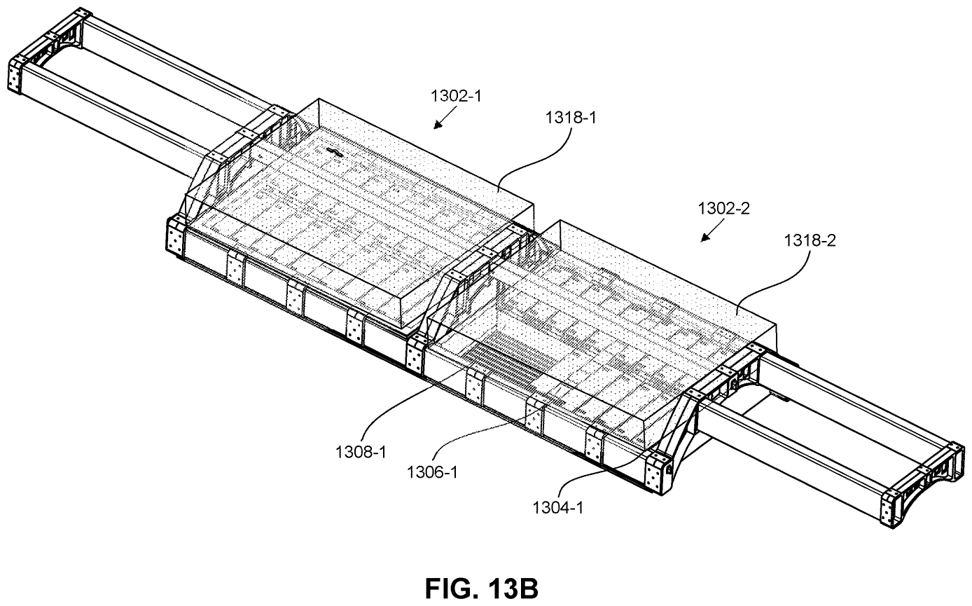

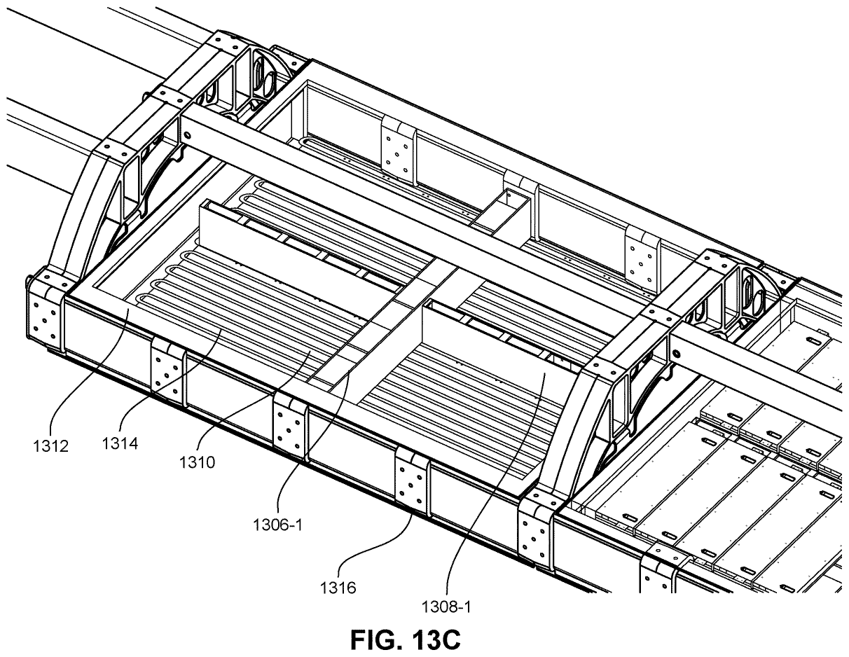

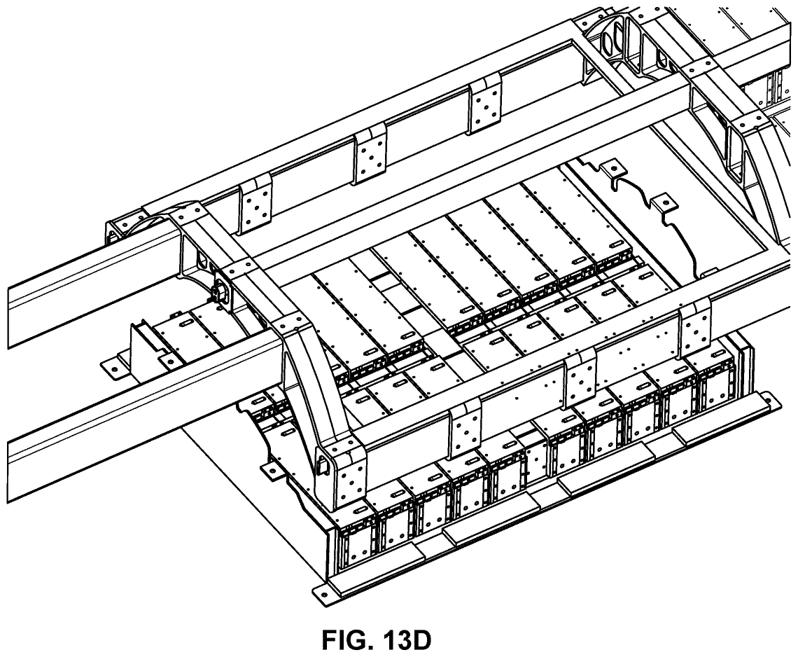

FIGS. 13A-13D illustrate an example chassis assembly 1300 that includes example battery pack storage modules (e.g., the battery pack storage modules 1302-1 and 1302-2), in accordance with some embodiments. Although the chassis assembly 1300 includes several specific structural details, one of skill in the art will appreciate that the battery pack storage modules and related components described with respect to FIGS. 13A-13D can be implemented with any of the other embodiments of chassis assemblies described herein.

FIG. 13A illustrates the chassis assembly 1300 with the two battery pack storage modules 1302-1 and 1302-2 integrated with frame members (e.g., frame members 102) of the chassis assembly 1300, in accordance with some embodiments. In some embodiments, the chassis assembly 1300 is an instance of the chassis assembly 100 (e.g., including one or more additional components not included in the chassis assembly 100).

In some embodiments a plurality of modules (e.g., comprising prismatic cells) are connected in series to construct a battery pack storage module (e.g., the battery pack storage module 1302-1) which can be attached, mounted, and/or structurally integrated into a frame member of the chassis assembly 1300 (e.g., attached to frame members 1352 and/or cross member 1354). In some embodiments, the battery cells are shaped as a rectangular prism (e.g., prismatic cells). However, the battery cells may be prismatic, cylindrical, pouch, or other type or chemistry of battery. In some embodiments, the frame members 1352 are instances of the frame members 102 described previously. In some embodiments, the cross member 1354 is an instance of the cross members 104 described previously.

In some embodiments, two or more of the battery pack storage modules are integrated with the chassis assembly 1300 in a modular fashion (e.g., they can be modularly sized and arranged based on dimensions of the wheel base). For example, a number of rows of battery cells on each respective battery pack storage module 1302 can be determined based on a maximum number of rows of battery cells that can fit between width of the wheel base of the chassis assembly 1300.

In some embodiments, an energy storage system such as the battery pack storage module 1302 is configured to utilize the frame rails (e.g., frame member 1352) as their enclosure walls, allowing seamless integration for assembly and disassembly for service. In some embodiments, a floor having a tray-like geometry is implemented under one or more of the battery pack storage module 1302, allowing a user of the chassis assembly 1300 to plug-and-play the integration of the battery pack storage modules 1302-1 and 1302-2. Such techniques can allow for a quick and efficient battery swap to reduce vehicle charging time. As will be discussed in more detail below, the floor of the battery pack assembly and various cross assembly structures can be implemented in conjunction with the battery pack storage module 1300 (e.g., to increase the torsional stability of the frame). In some embodiments, the battery pack storage module 1302 is arranged (e.g., mounted to) a belly pan (e.g., the modular belly pan assembly 1000).

In some embodiments, one or both of the battery pack storage modules 1302-1 and 1302-2 are covered with composite fiber-reinforced polymer (CFRP). The ceramic coating functions as an electromagnetic barrier, reducing or eliminating disturbances caused by EMI/RF (e.g., enhancing safety, performance, and/or efficiency). In some embodiments, both sides of the cover or a single side of the cover is optionally layered with a metallic or ceramic layer (e.g., a cover), which may provide an improved electromagnetic interference (EMI) barrier. In some embodiments, the cover is bonded to the inner wall of a frame member (e.g., a pultrusion) with high structural adhesive. In some embodiments, the adhesive is selected based on a material of the frame member and/or a cross member. In some embodiments, the internal space created by the cover is configurable as a high-pressure chamber stored for air or other liquid used in brake or energy production. The cover may serve as housing for different electrical connectors (e.g., protecting from environment exposure). In some embodiments, the cover is configured to constrain rotation in undesired direction. In some embodiments, the cover is configured and arranged as a mechanical fixture, configurable to protect respective electrical connectors of the battery pack storage modules 1302 from twisting forces, pulling forces, and/or rotational forces, as well as to provide protection from impacts.

In some embodiments, a high-voltage bus bar (e.g., any of the bus bars described herein) is provided to adapt one or both of the battery pack storage modules 1302 for high amperage current (e.g., for charging and discharging a heavy truck or other vehicle having high energy usage). In some embodiments, a sealing (e.g., a rubber sealing) is applied to the high-voltage bus bar (e.g., coating or wrapping around). In this way, the high-voltage bus bar can be IP 67 compliant and protected as an EMI shield. In some embodiments, a large composite cover is provided to protect the cell from the exterior environment. In some embodiments, two or more respective battery pack storage modules are stacked vertically, (e.g., for higher battery capacity of a longer charging range) and the respective vertical layers are optionally separated by a composite cover.

FIG. 13B illustrates an inner structure of the battery pack storage modules 1302-1 and 1302-2, in accordance with some embodiments. In some embodiments, a battery pack storage module 1302 includes two or more rows, such as the two rows of ten battery pack modules (e.g., a battery pack module 1304-1). In some embodiments, each row of modules includes two or more subsets of battery pack storage 1302 modules that are separated by a cross member. For example, the battery pack modules 1302-1 and 1302-2 each include two rows of battery pack modules that each include two subsets of five battery pack modules, which are separated by a cross member 1306-1 (e.g., a mid-cross member). In some embodiments, the battery pack storage modules 1302-1 and 1302-2 include a separator (e.g., a separator 1308-1) comprising the same or a different type of material from the cross member to separate rows of the respective battery pack storage module (e.g., two units of BMS enclosure separates each set of modules).

In some embodiments, the chassis assembly 1300 includes one or more components positioned above a battery pack storage module 1302. For example, the one or more components may include an energy storage system component and/or a tool storage component. In some embodiments, the space between the battery packs and a truck box is used for one or more additional components (e.g., corresponding to multiple purposes). In some embodiments, an additional layer of battery pack(s) is included (e.g., to double the energy storage capacity for long range truck). In some embodiments, the one or more components comprise a utility box. For example, in the case of utility/service truck, the space above the battery pack storage modules may be used as a utility box for a driver/operator. FIG. 13B shows the additional layer with two boxes indicating a front space 1318-1 above the battery pack storage module 1302-1 and a back space 1318-2 above the battery pack storage module 1302-2 in the front and back of the chassis assembly 1300, respectively. As another example, the front space 1318-1 above the battery pack storage module 1302-1 could be an additional battery pack and rear can be a utility box, or vice versa depending on the necessity nature of the vehicle type and range requirements.

FIG. 13C illustrates another aspect of the chassis assembly 1300 that includes a cold plate 1310 integrated into a chassis rail on both sides of the chassis assembly 1300 in accordance with some embodiments. In some embodiments, the chassis assembly 1300 includes a modular bottom plate, which can be a dual-purpose metallic cover (e.g., a cold plate). In some embodiments, the cold plate 1310 has a cover shape that includes one or more adaptations on the respective peripheries of the chassis assembly 1300. In some embodiments, the one or more adaptations are configured to integrally couple with a cross member of the chassis assembly 1300 (e.g., the cross member 1354). In some embodiments, the cold plate is configured and/or arranged to improve the aerodynamic flow of the air as well as function as a cold plate for the internal battery pack storage modules 1302-1 and 1302-2. In some embodiments, a direct touch of the moving air flow (e.g., air flowing under a vehicle as it drives) facilitates the bottom cover functioning as a cold plate, by efficiently dissipating heat from the battery pack storage modules 1302-1 and 1302-2. In some embodiments, the thickness of the cold plate 1310 is configured (e.g., thick enough) to handle impact forces from bottom (e.g., due to rocks or other objects scraping the underside of the vehicle), thereby enhancing the safety of the battery pack storage modules 1302-1 and 1302-2.

In some embodiments, the cold plate 1310 is adapted/configured to function as wall of the battery pack to provide impact safety from the side of the vehicle. In some embodiments, the chassis assembly 1300 includes another cold plate 1316 on an opposite side (e.g., a bottom side) from the side of the cold plate 1310. In some embodiments, the other cold plate 1316 is thicker than the cold plate 1310 (e.g., the other cold plate 1316 is composed of a thicker aluminum alloy). In some embodiments, one or both of the cold plate 1310 and the other cold plate 1316 includes a coolant line 1314 (e.g., a built-in spiral coolant line). In some embodiments, the cold plate 1316 and/or the coolant line 1314 provides structural support (e.g., to resist bottom impacts). In some embodiments, the separator 1308-1 includes two PCBs, each of which may be configured to couple with respective battery packs of the battery pack storage module 1302. In some embodiments, a sealant 1312 (e.g., a rubber sealant) is disposed at one or both of the top and bottom of the pack between the cover and frame rail. For example, two opposite side of the cross member 1306 may be secured to the hanger onto the frame rail.

As an example, a water-cooled cold plate with sufficient mass has been designed to serve as a structural element, enhancing the torsional rigidity of the chassis frame. The cold plate frame may be adapted to fit the hanger and cross member on the chassis frame, ensuring ease of assembly. In some embodiments, an aluminum alloy material is used for the cold plate frame (e.g., considering its thermal and physical properties). The mid cross member not only improves structural rigidity but can also function as a spacer for proper busbar arrangement and wire management. The top cover, e.g., composed of high-stiffness composite fiber (CFRP) material, may also improve the chassis' flexural and torsional rigidity.

FIG. 13D illustrates a drop-down design, where the cold plate design shown in FIG. 13C has been adapted to the crossmember, making aspects of the system easier to assemble and disassemble while minimizing the number fasteners (e.g., screws) that need to be released from a fastening position. Such embodiments may allow for quicker and more efficient removal of damaged or otherwise diminished battery packs (e.g., of the battery pack storage module 1302-1).

FIG. 14 illustrates a deflection force diagram 1400 indicating magnitudes of force acting on the chassis assembly during a simulated cornering sequence, in accordance with some embodiments. The diagram reflects that, while performing the simulated cornering, the left- or right-side rail will experience a sideways force (e.g., a normal force). In some embodiments, the systems described herein utilize cross-tying of composites to support a higher magnitude of deflective force. In some embodiments, the chassis assembly 1200 is configured to receive a maximum deflection of less than 50 millimeters (mm), 40 mm, or 37 mm.

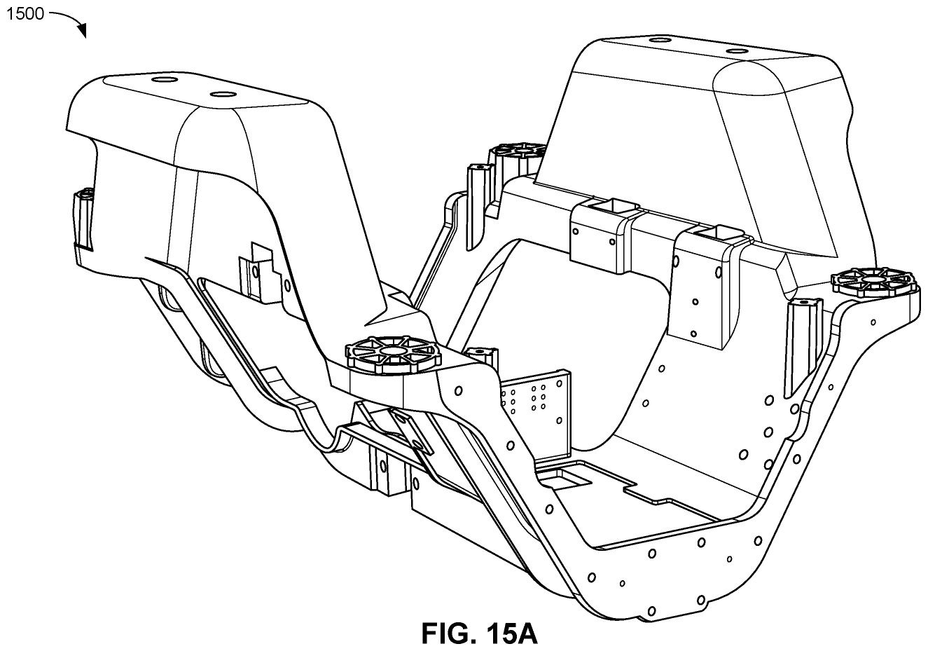

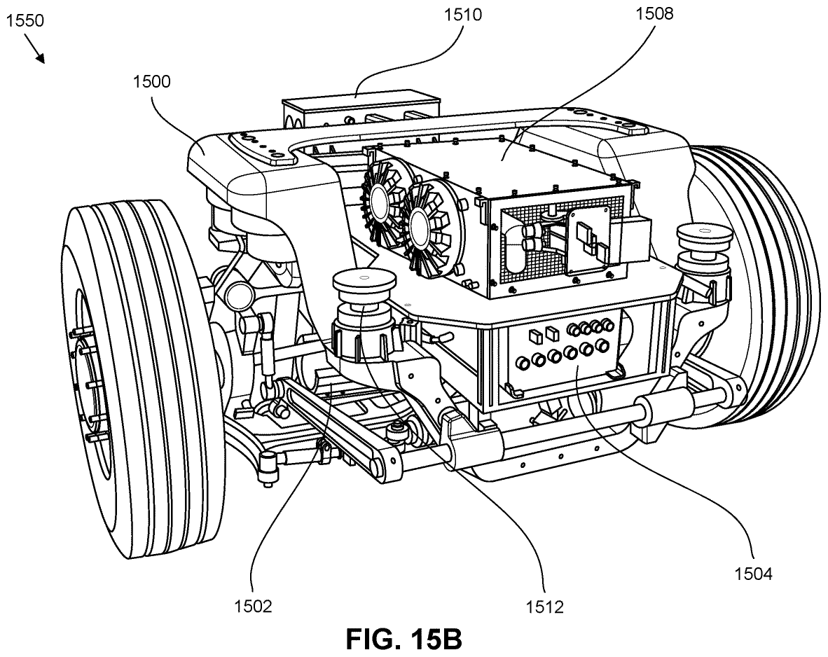

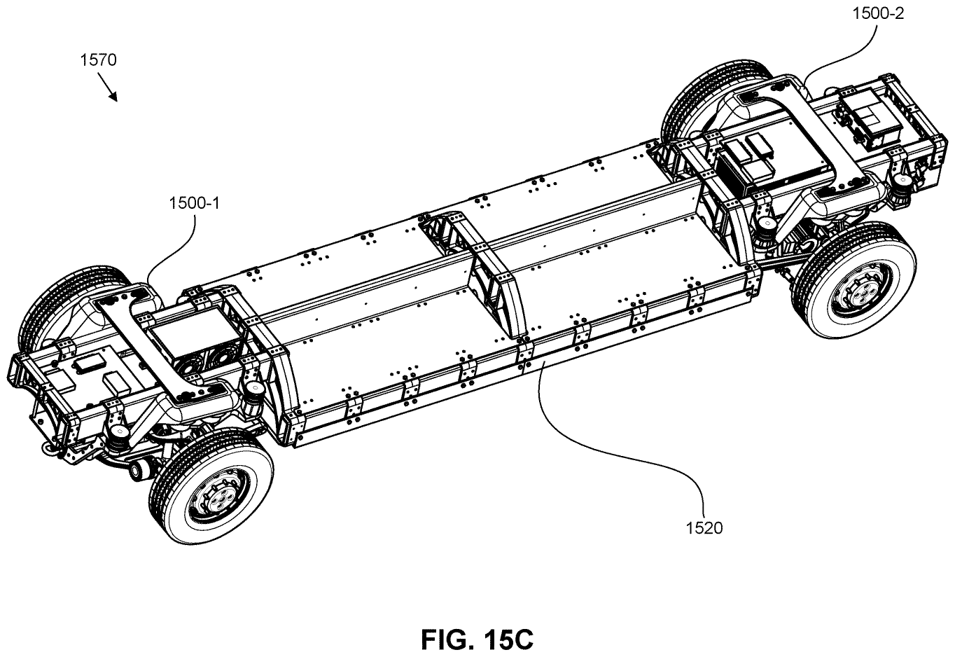

FIGS. 15A-15C illustrate an example cradle for use with a modular chassis assembly in accordance with some embodiments. FIG. 15A shows the cradle 1500, which may be provided through a casting process of an aluminum alloy. In some embodiments, the cradle 1500 includes one or more attachment points on the front and rear side of the cradle 1500, e.g., which can be adjusted by post-processing using the CNC machining process.

FIG. 15B shows the cradle 1500 as part of a shell assembly 1550 for a drivetrain. In some embodiments, the cradle geometry is designed as a shell for encompassing an entire drivetrain. In some embodiments, the motor and gearbox components of the powertrain are assembled within the bottom section of the cradle 1500, while the top remains open for auxiliary items such as the chiller, PDU, and charger inverter. In some embodiments, the cradle 1500 is configured to accommodate power steering, which can be added or left empty depending on the vehicle's steering type (e.g., RWD, FWD, or AWD). This shell-style powertrain differs from a distributed powertrain in which all the components are longitudinally spaced along the chassis ladder.

The cradle 1500 is shown integrated with the motor gearbox 1502 and other components of a steering motor, in accordance with some embodiments. In some embodiments, the shell assembly 1550 includes an anti-roll bar 1506 configured to minimize rolling of the vehicle body. The anti-roll bar 1506 (also sometimes referred to as a roll bar, anti-sway bar, sway bar, or stabilizer bar) may be a component of a vehicle's suspension system and configured to reduce/minimize body roll when the vehicle navigates sharp corners or encounters uneven road surfaces.

In some embodiments, the shell assembly 1550 includes a chiller 1508 for cooling one or more components of the shell assembly 1550 (e.g., motor gearbox 1502 and steering motor). In some embodiments, the shell assembly further includes one or more auxiliary components, such as a HV PDU 1504, a charger inverter 1510, and/or busing 1512. In some embodiments, the shell assembly 1550 incorporates the powertrain, suspension, axle, steering, braking, and wheel assembly and all HV and LV components. The consolidation of these components into the shell assembly 1550 can streamline the manufacturing process and may improve the structural integrity. In some embodiments, the design of the shell assembly 1550 allows for an 80% reduction in the bill of materials (BOM), indicating cost savings and potentially simpler supply chain management. For example, each powertrain and auxiliary component traditionally includes specific mounting brackets (e.g., with multiple parts including fasteners). By having a single cradle assembly, the components may be attached to a same component of the cradle assembly (e.g., a single plate) thereby reducing the materials needed.

In some embodiments, the shell assembly 1550 is incorporated as a floating subframe (e.g., by using bushings and/or other mounts), allowing for controlled movement and isolation. In some embodiments, the floating subframe configuration of the shell assembly 1550 supports the drivetrain securely while isolating vibrations and noise (e.g., similar to a floating subframe). In some embodiments, the floating sub-frame configuration of the shell assembly 1550 is configured to allow the drivetrain some movement relative to the truck chassis, which can absorb and dampen road irregularities and shocks. The floating aspect of the cradle 1500 may reduce one or more of noise, vibration, and harshness (together referred to as NVH) transmitted to the cabin, which can contribute to a quieter and more comfortable driving experience for a user of the chassis implementing the shell assembly 1550. For example, the floating aspect of the cradle 1500 can facilitate reduction/minimization of vibrations and noises transmitted to the cabin, contributing to a quieter and more comfortable driving experience. While isolating vibrations, the floating cradle 1500 is configurable to maintain precise handling characteristics, crucial in performance-oriented vehicles, and/or ensuring that engine and transmission movements are controlled, reducing potential adverse effects on handling. The design allows for a more responsive driving experience that is adaptable to changing road conditions and driving dynamics without transmitting harsh feedback to the occupants.

In accordance with some embodiments, the floating cradle 1500 offers design flexibility by balancing between handling benefits of a rigidly-mounted cradle, and comfort enhancements provided by a floating subframe. In some embodiments, the floating cradle 1500 is configured to be customizable such that it can be optimized for different levels of stiffness and isolation according to the specific needs of the vehicle for which the cradle 1500 is being implemented. In some embodiments, the floating cradle 1500 is configured to provide for independent suspension, by allowing the wheels to operate independently (e.g., the movement of one wheel does not cause movement at the opposite wheel). Such implementations can reduce an amount of bounce and vibration transmitted across the vehicle, leading to smoother ride characteristics. Further, independent suspension systems may maintain better contact with the road surface under various conditions because each wheel can react to bumps or dips independently. This improves traction and stability, which are important for safe driving. Additionally, maintaining independent alignment of each wheel can reduce tire wear and improves overall vehicle handling. In some embodiments, independent suspensions allow for extensive customization in terms of damping and stiffness, making it easier to tailor a vehicle's dynamics to specific performance requirements. For example, conventional components are connected directly to a frame and therefore are specific to the particular frame, whereas allowing sub-components to couple to the chassis via the cradle allows for various customizations.

FIG. 15C shows a twin cradle assembly that includes a first cradle 1500-1 on a front end of the chassis assembly 1520 and a second cradle 1500-2 on the rear of the chassis assembly 1520, thereby forming a twin cradle assembly 1570, in accordance with some embodiments. In some embodiments, the twin cradle assembly 1570 has a modular design that makes it easy to exchange between front and rear setup based on either a full-wheel drive (FWD), rear-wheel drive (RWD), and/or an all-wheel drive (AWD) arrangement. That is, in some embodiments, the cradle 1500 can be adapted for both all-wheel drive (AWD) and rear-wheel drive (RWD) configurations, providing flexibility for different vehicle types and driving conditions. In some embodiments, the cradle 1500 is adaptable to other types of chassis (e.g., a steel ladder chassis). By being designed as an independent unit that can autonomously integrate into the chassis frame, the cradle assembly can facilitate modular manufacturing processes, which can provide for faster assembly times and reduced overall production costs.

In some embodiments, the first and second cradles 1500-1 and 1500-2 are interchangeable (e.g., in a plug-and-play fashion) for either the front or rear end of the chassis assembly 1520. In some embodiments, the cradle 1500 includes attachment points, which may be located in specific locations (e.g., at four specific corners near the mid-plane of the cradle), which can facilitate easier integration with the chassis. In some embodiments, a varied hanger is used alternatively or additionally to the attachment points. In some embodiments, the varied hanger includes anchoring holes which are configured to serve as mounting points on the chassis. In some embodiments, the same four attachment points and/or anchoring holes on the cradle 1500 are configured for use in either the front or rear end of the chassis. In this way, the twin cradle assembly including the first cradle 1500-1 and the second cradle 1500-2 may provide improved performance, versatility, and efficiency. For example, the cradle 1500 may comprise a unitary cast metal alloy to consolidate several components of a vehicle into one integrated unit. In some embodiments, the entire assembly comprising the cradle 1500 is made from a single type of metal alloy, which may provide strength, durability, and/or weight savings compared to traditional assemblies made from multiple parts.

In some embodiments, the cradle 1500 is produced using a metal alloy casting process. In some embodiments, the cradle 1500 is made of casted aluminum that undergoes heat treatment to improve ductility and reduce internal stresses before machining to more exact tolerances on the shapes. In some embodiments, the cradle 1500 comprises other metals or composite materials. Machining and die-casting are alternative production methods for different metallic materials described herein. For fiber composite materials, hand lay-up, heated compression molding, resin transfer molding, and other common fabrication methods can be used.

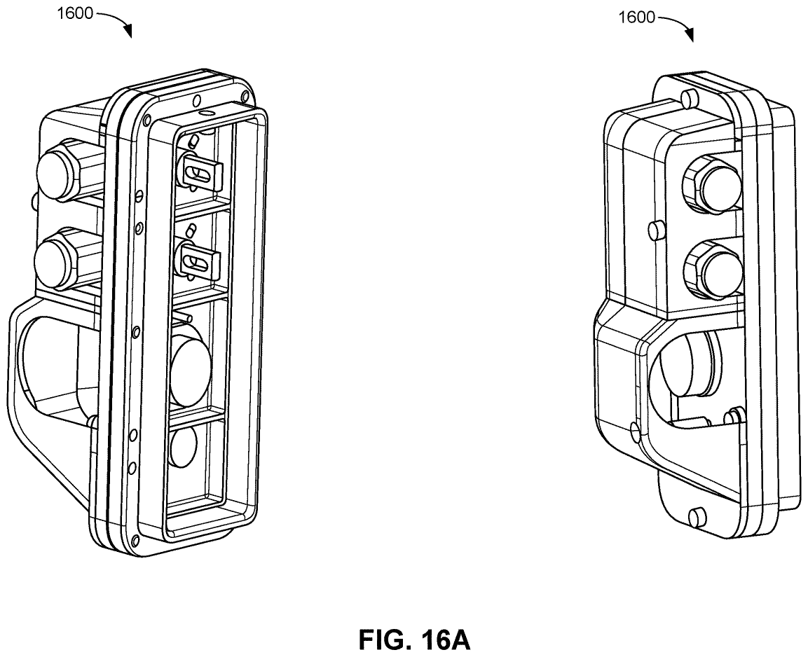

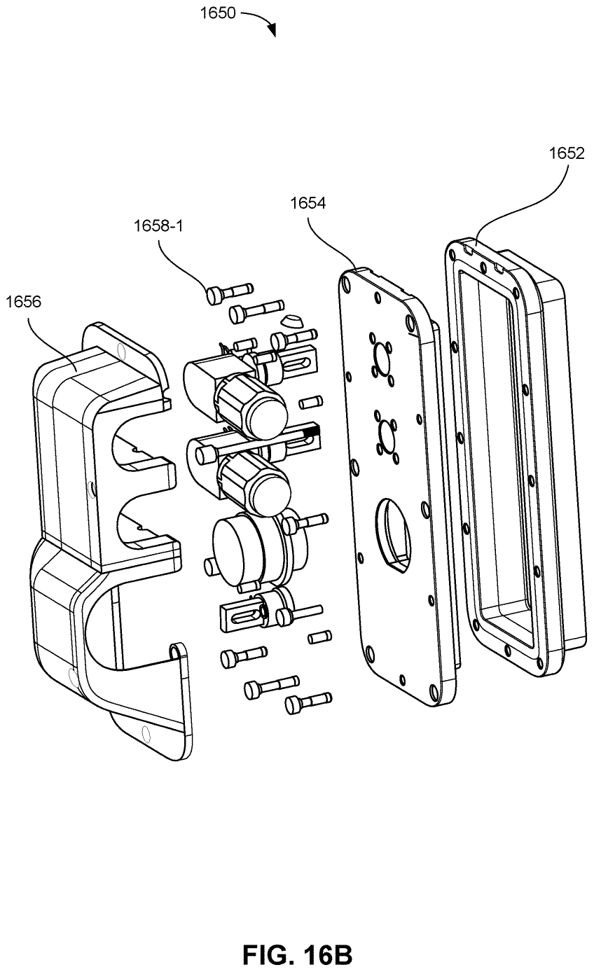

FIGS. 16A and 16B illustrate a pultrusion cover 1600, in accordance with some embodiments. In some embodiments, the pultrusion cover 1600 is configured to couple with the end plate 604 of the frame member 102 shown in FIGS. 6A-6B. In some embodiments, the pultrusion cover includes one or more components configured to couple with respective connectors protruding from the end plate 604 (e.g., the connector 606, and/or the connectors 608-1 and 608-2).

FIG. 16A shows a first perspective view of the pultrusion cover 1600, in accordance with some embodiments. FIG. 16B shows an exploded view of the pultrusion cover 1600, in accordance with some embodiments. In some embodiments, the pultrusion cover 1600 includes a flange 1652, which may be configured to attach to one or more inner walls of a pultrusion (e.g., via a structural adhesive). The pultrusion cover 1600 includes a middle plate 1654, which may be configured to function as a mounting points for one or more connectors of the pultrusion. The pultrusion cover 1600 can also include an outer cover 1656, which may be configured to protect one or more assemblies within the pultrusion cover 1600 from impact and/or environmental conditions. In some embodiments, the pultrusion cover 1600 is sized to house one or more components (e.g., a fastener component 1658-1) that are configured to allow for mechanically and/or electrical coupling between the pultrusion cover 1600 and one or more connectors of a frame member of the chassis assembly.

Turning now to some example embodiments.

(A1) In one aspect, some embodiments include a multi-plane chassis assembly (e.g., the chassis assembly 100) that includes: (i) a plurality of pultruded frame members (e.g., the frame members 102), a first subset of the pultruded frame members being arranged on a first structural plane (e.g., the frame members 102-1 and 102-4 on the plane indicated by dashed lines 114), and a second subset of the pultruded frame members being arranged on a second structural plane (e.g., the frame members 102-2 and 102-5 on the plane indicated by dotted lines 112), the first structural plane being at a different vertical position than the second structural plane; and (ii) a plurality of cross members (e.g., the cross members 104-2, 104-3, and 104-4) connecting the plurality of pultruded frame members to one another, the plurality of cross members are connected to the plurality of pultruded frame members and arranged to maintain a geometric relationship between pultruded frame members of the plurality of pultruded frame members, where each cross member of the plurality of cross members extends between at least two structural planes. In some embodiments, the multi-plane chassis assembly includes a plurality of metal frame members (e.g., the frame members 202), e.g., in addition, or alternatively, to the plurality of pultruded frame members.

(A2) In some embodiments of A1, the plurality of pultruded frame members is arranged to support longitudinal loads. In some embodiments, the plurality of pultruded frame members is arranged to support longitudinal, lateral, and/or off-axis loads. In some embodiments, the pultruded frame members are arranged to support a vehicle cabin, a suspension system, a powertrain, a brake system, a steering system, an actuator system, power electronics, and/or a power distribution unit.

(A3) In some embodiments of A1 or A2, the multi-plane chassis assembly further includes one or more chassis brackets (e.g., the bracket 106 and/or the bracket 108) connected to the plurality of pultruded frame members and/or the plurality of cross members, the one or more chassis brackets are shaped to couple one or more components to the multi-plane chassis assembly.

(A4) In some embodiments of A3, the multi-plane chassis assembly further includes an interlocking bracket coupling (e.g., attachment system 809 or 811) shaped to couple a chassis bracket of the one or more chassis brackets to a mechanical attachment (e.g., the attachment bracket 814), the interlocking bracket coupling including a tapered lock interface. In some embodiments, the interlocking bracket coupling comprises a two-part fastener (e.g., the two-part fastener 812). In some embodiments, the interlocking bracket coupling comprises a locking mechanism (e.g., the shear pins 820).

(A5) In some embodiments of any of A1-A4, the multi-plane chassis assembly further includes one or more tanks (e.g., the tanks 302 and/or 304) coupled to the multi-plane chassis assembly between the plurality of pultruded frame members. In some embodiments, the one or more tanks are arranged between the first structural plane and the second structural plane (e.g., as illustrated in FIGS. 3A and 3B). In some embodiments, the one or more tanks include two or more tanks having different sizes. For example, the one or more tanks include an integrated inner tank (e.g., the tank 304) and one or more smaller outer tanks (e.g., the tanks 302). In some embodiments, the one or more outer tanks are positioned to reduce (e.g., minimize) the torsional loads and bending loads on the integrated inner tank.

(A6) In some embodiments of A5, a tank of the one or more tanks is connected to an interior of a cross member (e.g., the cross member 104-1 in FIG. 3B) of the plurality of cross members. In some embodiments, the one or more tanks includes a plurality of tanks fluidically coupled to one another (e.g., via an air, gas, or fuel inlet). For example, FIG. 3B shows the tanks 352-1 and 352-2 coupled to one another via the tank connector 354.

(A7) In some embodiments of A5 or A6, the one or more tanks are arranged to provide torque and bend resistance to the multi-plane chassis assembly. In some embodiments, the one or more tanks are composed of metal and/or composite fibers.

(A8) In some embodiments of any of A1-A7, the multi-plane chassis assembly further includes one or more bus bars (e.g., the bus bars 402) embedded in the plurality of pultruded frame members. In some embodiments, the embedded bus bar(s) are composed of an electrically-conductive material. For example, a first pultruded frame member includes a first bus bar configured to function as a negative electrical line (e.g., coupled to an electrical ground and/or a negative output of a power supply), and a second pultruded frame member includes a second bus bar configured to function as a positive electrical line (e.g., coupled to a positive output of a power supply). In some embodiments, the embedded bus bar(s) are substantially encased in an electrically-insulating material (e.g., to prevent electrical shorts to one or more other components of the chassis assembly). In some embodiments, the embedded bus bar(s) are configured to generate resistive heat (e.g., function has electrical resistors). For example, an embedded bus bar is composed of an electrically-resistive material. In some embodiments, the frame members are composed of an electrically-insulating and thermally-conductive material.

(A9) In some embodiments of any of A1-A8, the multi-plane chassis assembly further includes one or more bus bars (e.g., the bus bars 452) bonded to the plurality of pultruded frame members. For example, one or more bus bars may be bonded to an interior volume of a pultruded frame member.

(A10) In some embodiments of any of A1-A9, the multi-plane chassis assembly further includes one or more components (e.g., the tanks 508, the interior connector 602, and/or the interior connectors 710) arranged within an interior volume of a pultruded frame member of the plurality of pultruded frame members. For example, the one or more components may include one or more electronic components, one or more cables, one or more pipes, one or more accumulators, one or more sensors, one or more pneumatic components, and/or one or more connectors.

(A11) In some embodiments of any of A1-A10, a pultruded frame member of the plurality of pultruded frame members includes at least one connector component (e.g., the lateral connectors 702). In some embodiments, the at least one connector component includes one or more of: a piping connector (e.g., a piping bulkhead connector), a power connector, and a communications connector. In some embodiments, the at least one connector component includes a multiplex connector.

(A12) In some embodiments of A11, the at least one connector component is arranged on an end cover (e.g., the end plate 604) of the pultruded frame member.

(A13) In some embodiments of any of A1-A12, the multi-plane chassis assembly further includes one or more electrical contactors (e.g., the electrical contactors 650) and one or more electrical bus bars (e.g., the bus bars 652) connected to an interior volume of a pultruded frame member of the plurality of pultruded frame members. In some embodiments, the electrical contactors are controller area network (CAN bus) controlled. In some embodiments, the electrical contactors are smart contactors. In some embodiments, the electrical contactors are insulated gate bipolar transistor (IGBT) controlled. In some embodiments, an external controller controls the electrical contactors. In some embodiments, the electrical contactors operate based on data from one or more sensors (e.g., collocated sensors). In some embodiments, the electrical contactors are solid state contactors. In some embodiments, the chassis assembly includes a centralized power control and a plurality of electrical contactors (e.g., in place of a PDU such that the chassis assembly and associated vehicle do not include a PDU). In some embodiments, the electrical contactors are in two-way communication with a centralized power control. For example, the electrical contactors send information regarding operating conditions to the centralized power control and the centralized power control sends operating instructions to the electrical contactors. For example, an electrical contactor can toggle off in response to heat and/or power exceeding a threshold and notify the centralized power control that the contactors has toggled off (and/or the heat/power conditions). In this example, the centralized power control can address the issue that caused the excessive heat/power and then send a request to the electrical contactors to toggle back on.

(A14) In some embodiments of any of A1-A13, a cross member of the plurality of cross members includes one or more electrically-resistive elements (e.g., the heat elements 902). In some embodiments, the one or more electrically-resistive elements are configured to dissipate heat. For example, the one or more electrically-resistive elements are electrically coupled to a battery component and configured to convert current from the battery component to heat. In some embodiments, the cross member of the plurality of cross members includes one or more thermal heat exchanger components. In some embodiments, the electrically-resistive elements are selectively coupled to a power system (e.g., including one or more capacitors and/or one or more batteries) via one or more electrical switches (e.g., one or more electrical contactors). In some embodiments, the electrically-resistive elements are selectively coupled to the power system via one or more bus bars and one or more electrical contactors. In some embodiments, the one or more electrical switches are responsive to a wireless signal (e.g., from a first responder) to electrically couple the electrically-resistive elements to the power system. In some embodiments, the one or more electrical switches are coupled to a communications system and electrically couple the electrically-resistive elements to the power system in response to an error signal from the communications system (e.g., the error signal indicative of a vehicle malfunction and/or collision). In some embodiments, the error signal is generated in response to a determination that batteries of the power system are full of charge (e.g., cannot be safely charged further). In some embodiments, the electrically-resistive elements convert electrical power from the power system to heat (e.g., to remove excessive charge from the power system). In some embodiments, the electrically-resistive elements are sized based on a full charge of the power system. For example, the electrically-resistive elements are selected and/or sized based on a full charge from the power system, e.g., selected and/or sized to be able to burn off a full charge from the power system within a predetermined amount of time (e.g., 10 minutes). In some embodiments, the electrically-resistive elements of a first cross member are sized differently than electrically-resistive elements of a second cross member. In some embodiments, the first cross member has a different number of the electrically-resistive elements than the second cross member. In some embodiments, the electrically-resistive elements of a first cross member are connected to the power system to convert excessive battery charge during vehicle operation. In some embodiments, the electrically-resistive elements of a second cross member are connected to the power system to drain electrical charge from the power system (e.g., in the event of a vehicle malfunction and/or collision). In some embodiments, in response to an error signal (e.g., due to a vehicle malfunction and/or collision), a first set of electrically-resistive elements are electrically coupled to the power system at a first time and a second set of electrically-resistive elements are electrically coupled to the power system at a second time. For example, the first set of electrically-resistive elements are used to dissipate electrical charge until a temperature of the first set exceeds a predetermined threshold. In this example, in response to the temperature of the first set exceeding the predetermined threshold, the second set of electrically-resistive elements are coupled to the power system.

(A15) In some embodiments of any of A1-A14, the multi-plane chassis assembly further includes one or more tanks (e.g., the tanks 508) arranged in an interior volume of a pultruded frame member of the plurality of pultruded frame members. For example, the one or more tanks include an air tank, a gas tank, and/or a fuel tank. In some embodiments, the one or more tanks form a hydraulic accumulator assembly. In some embodiments, the one or more tanks include a plurality of tanks coupled in parallel or in series with one another.

(A16) In some embodiments of any of A1-A15, a pultruded frame member of the plurality of pultruded frame members is connected to a cross member of the plurality of cross members via an adhesive captive joint (e.g., as illustrated and described with respect to FIGS. 8A and 8B). In some embodiments, the cross member includes an adhesive injection point. In some embodiments, the adhesive captive joint includes an adhesive material arranged in an internal volume between the cross member and the pultruded frame member.

(A17) In some embodiments of any of A1-A16, the multi-plane chassis assembly further includes a modular belly pan assembly (e.g., the belly pan assembly 1000) coupled to the plurality of pultruded frame members. In some embodiments, the modular belly pan assembly includes a plurality of discrete pultrusions (e.g., the pultrusions 1002, 1004, and 1006) and/or extrusions. For example, the pultrusions and/or extrusions are shaped to connect modular sections of the modular belly pan assembly. In some embodiments, the modular belly pan assembly is shaped and positioned to improve aerodynamics of the multi-plane chassis assembly and/or a vehicle that includes the multi-plane chassis assembly. In some embodiments, the modular belly pan assembly includes one or more of: mechanical fasteners, welds, and/or adhesives. In some embodiments, the modular belly pan assembly is a pultruded composite belly ban assembly.

(A18) In some embodiments of any of A1-A17, a cross member of the plurality of cross members is connected to a pultruded frame member of the plurality of pultruded frame members via an adjustable coupler component (e.g., the joint system 828). For example, the adjustable coupler component includes a servo drive mechanism (e.g., the drive component 830) and/or a screw thread interface (e.g., the interface 832). In some embodiments, the adjustable coupler component is configured to adjust a positioning of the cross member with respect to the pultruded frame member. In some embodiments, the adjustable coupler component is configured to adjust the coupling position of the cross member during vehicle operation (e.g., to adjust a wheelbase of the vehicle). For example, the wheelbase of the vehicle is adjusted to change a turn radius of the vehicle and/or change an underride protection for the vehicle. In some embodiments, the coupling position of the cross member is adjusted during vehicle operation to improve stability of the vehicle (e.g., based on driving conditions). In some embodiments, the adjustable coupler component includes one or more linear actuators and/or a linear servo drive.

(A19) In some embodiments of any of A1-A18, the multi-plane chassis assembly further includes a cover assembly coupled to the plurality of pultruded frame members (e.g., as illustrated in FIG. 13A), the cover assembly configured to reduce electromagnetic interference of components mounted to the plurality of pultruded frame members. In some embodiments, the cover assembly comprises a ceramic coating. In some embodiments, the cover assembly comprises a carbon fiber-reinforced plastic. In some embodiments, the cover assembly includes a sealing component (e.g., a gasket or seal, such as a rubber seal) for sealing the cover assembly to the plurality of pultruded frame members (e.g., the frame member 102 shown in FIGS. 6A-6B).

(A20) In some embodiments of any of A1-A19, the multi-plane chassis assembly further includes a set of battery components mounted to the plurality of pultruded frame members (e.g., the battery pack storage modules 1302). In some embodiments, the set of battery components are arranged within a battery enclosure. In some embodiments, the set of battery components comprises four or more components (e.g., two rows of ten individual battery pack modules 1304). In some embodiments, the set of battery components are arranged on a cold plate (e.g., the cold plate 1310). In some embodiments, the set of battery components are arranged on a skateboard chassis that is mounted to the plurality of pultruded frame members.

(A21) In some embodiments of any of A1-A20, the multi-plane chassis assembly further includes a cold plate mounted to the plurality of pultruded frame members (e.g., as illustrated in FIG. 13C). In some embodiments, one or more cooling lines are integrated with the cold plate (e.g., the coolant line 1314). In some embodiments, the cold plate (and components mounted to the cold plate) are detachably coupled to the plurality of pultruded frame members (e.g., configured to drop down for ease of assembly, disassembly, and maintenance).

(A22) In some embodiments of any of A1-A21, the multi-plane chassis assembly further includes a cradle assembly (e.g., the shell assembly 1550 including the cradle 1500) attached to the plurality of pultruded frame members, the cradle assembly configured to support a drive train of a vehicle. In some embodiments, the cradle assembly is coupled to a first end of the multi-plane chassis assembly, and the multi-plane chassis assembly further comprises a second cradle assembly coupled to a second end of the multi-plane chassis assembly, the second end being opposite of the first end.

(A23) In some embodiments of any of A1-A22, the multi-plane chassis assembly further includes a cover assembly (e.g., the pultrusion cover 1600) attached to a pultruded frame member of the plurality of pultruded frame members, the cover assembly attached to an end of pultruded frame member and configured to provide a set of connectors for components within the pultruded frame member.

In another aspect, a multi-plane chassis assembly includes a plurality of pultruded frame members. A first subset of the pultruded frame members is arranged on a first structural plane, and a second subset of the pultruded frame members is arranged on a second structural plane. The first structural plane is distinct from the second structural plane (e.g., the first structural plane is non-parallel to the second structural plane and/or an extension of the first structural plane does not intersect with the second structural plane). The multi-plane chassis assembly also includes a plurality of cross members. A respective cross member of the plurality of cross members is connected to two or more pultruded frame members of the plurality of pultruded frame members. In some embodiments, each cross member of the plurality of cross members extends between at least two structural planes. In some embodiments, the multi-plane chassis assembly has one or more features described above with respect to any of A1-A22.

In another aspect, a multi-plane chassis assembly includes a plurality of pultruded frame members. A first subset of the pultruded frame members is arranged at a first height (e.g., from a reference plane), and a second subset of the pultruded frame members is arranged at a second height (e.g., from the reference plane) distinct from the first height. The multi-plane chassis assembly also includes a plurality of cross members. A respective cross member of the plurality of cross members is connected to two or more pultruded frame members of the plurality of pultruded frame members. In some embodiments, each cross member of the plurality of cross members extends between from the first height to the second height. In some embodiments, the multi-plane chassis assembly has one or more features described above with respect to any of A1-A22.

In another aspect, a chassis assembly includes a plurality of pultruded frame members. A first subset of the pultruded frame members defines a first structural plane, and a second subset of the pultruded frame members defines a second structural plane. The first structural plane is distinct from the second structural plane (e.g., the first structural plane is non-parallel to the second structural plane and/or an extension of the first structural plane does not intersect with the second structural plane). The chassis assembly also includes a plurality of cross members. A respective cross member of the plurality of cross members is connected to two or more pultruded frame members of the plurality of pultruded frame members. In some embodiments, each cross member of the plurality of cross members extends between at least two structural planes. In some embodiments, the multi-plane chassis assembly has one or more features described above with respect to any of A1-A22.

(B1) In another aspect, some embodiments include a vehicle that includes: (i) the multi-plane chassis assembly of any of A1-A22; and (ii) a cab assembly (e.g., the cab assembly 1100) removably coupled to the multi-plane chassis assembly via a hinge pivot assembly (e.g., the connection component 1102). In some embodiments, the cab assembly includes an integrated energy storage component. In some embodiments, the hinge pivot assembly allows the cab to rotate up (e.g., for maintenance and/or removal) with respect to a chassis assembly.

(B2) In some embodiments of B1, the hinge pivot assembly includes a pivot bracket (e.g., the pivot bracket 1106) and a pivot joint receiver bracket (e.g., the pivot joint receiver 1104). In some embodiments, the pivot assembly is configured such that rotation of the pivot joint to a preset angle enables the cab assembly to be detached from the multi-plane chassis assembly.

(B3) In some embodiments of B1 or B2, the cab assembly includes a power connector (e.g., the cab connector 1115) and/or a communication connector (e.g., the cab connector 1118). In some embodiments, each connector is a plug-and-play connector.

In some embodiments, the chassis assembly is suitable for vehicles of various shapes, sizes, and weight classes. In some embodiments, the chassis assembly includes pultruded structural composite components. In some embodiments, the chassis assembly includes extruded aluminum structural components. In some embodiments, the chassis assembly includes steel structural components. In some embodiments, the chassis assembly includes integrated high voltage bus bar assemblies. In some embodiments, the chassis assembly includes integrated low voltage bus bar assemblies. In some embodiments, the chassis assembly includes one or more structurally integrated PDUs. In some embodiments, the chassis assembly includes one or more suspension and drivetrain cradle modules (e.g., that interact with one another via a wired or wireless programmable interface). In some embodiments, the chassis assembly includes cross members adapted to function as integrated heat exchangers and/or resistive heating elements (e.g., for dissipation of heat and/or electrical energy). In some embodiments, the chassis assembly includes one or more tamper-resistant battery pack attachment mechanisms. In some embodiments, the chassis assembly includes one or more tamper-resistant suspension and drivetrain cradle module attachment mechanisms. In some embodiments, the chassis assembly includes one or more compressed air or hydraulic tanks (e.g., that may serve as a structural member). In some embodiments, the chassis assembly includes frame rails that serve as one or more fuel tanks (e.g., for low storage pressure fuels such as gasoline, diesel, or bio-derived liquid fuels). In some embodiments, the chassis assembly includes one or more integrated high pressure fuel tanks (e.g., that serve as structural frame rails). In some embodiments, the chassis assembly includes forward and/or rear frame members that contain the pressure regulation equipment. In some embodiments, the chassis assembly includes one or more captive adhesive bonded joints. In some embodiments, the chassis assembly includes a modular chassis belly pan. In some embodiments, the chassis assembly includes one or more frame members that enable variable slide out wheelbase adjustment. In some embodiments, the chassis assembly is configured as an autonomous trailer. In some embodiments, the chassis assembly includes a modular plug-and-play operator cab configuration. In some embodiments, the chassis assembly includes an axle articulation system.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

1. A multi-plane chassis assembly, comprising:
a plurality of pultruded frame members, a first subset of the pultruded frame members being arranged on a first structural plane, and a second subset of the pultruded frame members being arranged on a second structural plane, the first structural plane being at a different vertical position than the second structural plane; and
a plurality of cross members connecting the plurality of pultruded frame members to one another, the plurality of cross members are connected to the plurality of pultruded frame members and arranged to maintain a geometric relationship between pultruded frame members of the plurality of pultruded frame members, wherein each cross member of the plurality of cross members extends between at least two structural planes and connects at least one pultruded frame member of the second subset of pultruded frame members between a set of pultruded frame members of the first subset of pultruded frame members, wherein each cross member of the plurality of cross members includes a set of adhesive captive joints securing the respective pultruded frame members from the plurality of pultruded frame members, wherein each adhesive captive joint of the set of adhesive captive joints includes a respective injection point to insert adhesive material in an internal volume between the cross member and the pultruded frame member.

2. The multi-plane chassis assembly of claim 1, wherein the plurality of pultruded frame members are arranged to support longitudinal loads.

3. The multi-plane chassis assembly of claim 1, further comprising one or more chassis brackets connected to the plurality of pultruded frame members and/or the plurality of cross members, the one or more chassis brackets are shaped to couple one or more components to the multi-plane chassis assembly.

4. The multi-plane chassis assembly of claim 3, further comprising an interlocking bracket coupling shaped to couple a chassis bracket of the one or more chassis brackets to a mechanical attachment, the interlocking bracket coupling including a tapered lock interface.

5. The multi-plane chassis assembly of claim 1, further comprising one or more tanks coupled to the multi-plane chassis assembly between the plurality of pultruded frame members.

6. The multi-plane chassis assembly of claim 5, wherein a tank of the one or more tanks is connected to an interior of a cross member of the plurality of cross members.

7. The multi-plane chassis assembly of claim 5, wherein the one or more tanks are arranged to provide torque and bend resistance to the multi-plane chassis assembly.

8. The multi-plane chassis assembly of claim 1, further comprising one or more bus bars embedded in the plurality of pultruded frame members.

9. The multi-plane chassis assembly of claim 1, further comprising one or more bus bars bonded to the plurality of pultruded frame members.

10. The multi-plane chassis assembly of claim 1, further comprising one or more components arranged within an interior volume of a pultruded frame member of the plurality of pultruded frame members.

11. The multi-plane chassis assembly of claim 1, wherein a pultruded frame member of the plurality of pultruded frame members includes at least one connector component configured to couple to a component arranged within the pultruded frame member, wherein the at least one connector component comprises an electrical connector or a fluidic connector.

12. The multi-plane chassis assembly of claim 1, further comprising one or more electrical contactors and one or more electrical bus bars connected to an interior volume of a pultruded frame member of the plurality of pultruded frame members.

13. The multi-plane chassis assembly of claim 1, wherein a cross member of the plurality of cross members includes one or more electrically-resistive elements.

14. The multi-plane chassis assembly of claim 1, further comprising one or more tanks arranged in an interior volume of a pultruded frame member of the plurality of pultruded frame members.

15. (canceled)

16. The multi-plane chassis assembly of claim 1, further comprising a modular belly pan assembly coupled to the plurality of pultruded frame members.

17. The multi-plane chassis assembly of claim 1, further comprising a cover assembly coupled to the plurality of pultruded frame members, the cover assembly having a ceramic layer configured to reduce electromagnetic interference of components mounted to the plurality of pultruded frame members.

18. The multi-plane chassis assembly of claim 1, further comprising a cradle assembly attached to the plurality of pultruded frame members, the cradle assembly configured to support a drive train of a vehicle.

19. The multi-plane chassis assembly of claim 1, further comprising a cover assembly attached to a pultruded frame member of the plurality of pultruded frame members, the cover assembly attached to an end of pultruded frame member and configured to provide a set of connectors for components within the pultruded frame member.

20. A vehicle, comprising:
a multi-plane chassis assembly comprising:
a plurality of pultruded frame members, a first subset of the pultruded frame members being arranged on a first structural plane, and a second subset of the pultruded frame members being arranged on a second structural plane, the first structural plane being at a different vertical position than the second structural plane; and
a plurality of cross members connecting the plurality of pultruded frame members to one another, the plurality of cross members are connected to the plurality of pultruded frame members and arranged to maintain a geometric relationship between pultruded frame members of the plurality of pultruded frame members, wherein each cross member of the plurality of cross members extends between at least two structural planes and connects at least one pultruded frame member of the second subset of pultruded frame members between a set of pultruded frame members of the first subset of pultruded frame members, wherein each cross member of the plurality of cross members includes a set of adhesive captive joints securing the respective pultruded frame members from the plurality of pultruded frame members, wherein each adhesive captive joint of the set of adhesive captive joints includes a respective injection point to insert adhesive material in an internal volume between the cross member and the pultruded frame member; and
a cab assembly removably coupled to the multi-plane chassis assembly via a hinge pivot assembly.

21. The vehicle of claim 20, wherein the hinge pivot assembly comprises a pivot bracket and a pivot joint receiver bracket.

22. (canceled)

23. (canceled)

24. (canceled)
